(19) United States
(12) Patent Application Publication
(10) Pub. No.: US 2010/0095828 A1
(43) Pub. Date: Apr. 22, 2010

(54) Electronic System, Methods and Apparatus for Teaching and Examining Music

(75) Inventor: Jonathan Adams, Moratfield (AU)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Web Ed. Development Pty., Ltd., Strathpine (AU)

(21) Appl. No.: 12/575,311

(22) Filed: Oct. 7, 2009

Related U.S. Application Data
(63) Continuation-in-part of application No. 12/518,930, filed on Jun. 12, 2009.

(30) Foreign Application Priority Data
Dec. 13, 2006 (AU) 2006906973
Dec. 13, 2007 (AU) PCT/AU2007/001922

(51) Int. Cl. G09B 15/00

(52) U.S. Cl. 84/470 R

(57) ABSTRACT

Electronic systems, methods and apparatus for teaching and examining music and other subjects require that tasks be performed by a user. One method includes presenting a user with one or more musical tasks and providing a menu with one or more selectable icons. Selection of one of the icons activates functionality to enable the user to form an element of musical notation. The method includes comparing one or more characteristics of the element of musical notation with one or more predetermined thresholds in response to a user request and generating a mark, score or grade based on the result of the comparison.

### RELATED APPLICATIONS

This is a Continuation-in-part of U.S. patent application Ser. No. 12/518,930, filed 12 Jun. 2009, pending, which is a 371 U.S. National Phase of International Patent Application No. PCT/AU2007/001922 filed 13 Dec. 2007, which claims priority to Australian Patent Application No. 2006-906973, filed 13 Dec. 2006. The contents of the aforementioned patent applications are incorporated by reference in their entirety.

### FIELD OF THE INVENTION

The present invention relates to an electronic system, methods and apparatus for teaching and examining in the field of music and in other subjects, such as, but limited to, mathematics, languages and humanities, such as geography.

### BACKGROUND TO THE INVENTION

Music theory is the study of the elements of music including rhythm, harmony, melody, structure and texture and students learn how to read, write and analyse music and all its components. For centuries, the process of teaching and learning music theory and the process of examining students and their level of proficiency has remained unchanged. Even today, conventional books are still used to teach students how to read, write and analyse music and examinations in music theory are still undertaken and marked manually. Disadvantages associated with such a process include the time and cost in printing the books and marking the examination papers, the minimal feedback that is provided to students in relation to their examinations and the delay in providing the results of the examinations and feedback to the students.

Modern technology has provided some advancement in the field of writing, teaching, printing and publishing music. For example, numerous software packages are available that enable composers to electronically write music via a computer. One example of such software is Sibelius 4 available from Sibelius Software, which comprises a plurality of toolbars and menus from which a composer can select the desired notes and other musical notation to compose a score. The software can automatically update instrumental parts when the full score is updated and the software also plays the composed score allowing composers to listen to their composition. A further enhancement includes video for which music can be written via the software. Teaching aspects of the software include lesson plans and explanations of musical concepts.

However, such software applications do not educate students how to correctly form the notes and other musical notation, how to correctly position them or other aspects of writing music. Such software applications also fail to address the aforementioned drawbacks associated with examining students and marking students' examination papers.

Software applications for teaching other subjects, such as mathematics, languages and humanities, such as geography, are also available, but such applications also suffer from one or more drawbacks related to the particular subject similar to the music-specific drawbacks identified above.

In this specification, the terms “comprises”, “comprising” or similar terms are intended to mean a non-exclusive inclusion, such that a method, system or apparatus that comprises a list of elements does not include those elements solely, but may well include other elements not listed.

### OBJECT OF THE INVENTION

It is an object of the present invention to address or at least ameliorate one or more of the aforementioned problems of the prior art or provide a useful commercial alternative.

### SUMMARY OF THE INVENTION

In one form, although it need not be the only or indeed the broadest form, the invention resides in a method of teaching and examining in the field of music, said method including:

presenting a user with one or more musical tasks;

providing a menu with one or more selectable icons, selection of one of said icons activating functionality to enable the user to form an element of musical notation; and

generating a mark based on the result of comparing one or more characteristics of the element of musical notation with one or more predetermined thresholds.

Suitably, comparing one or more characteristics of the element of musical notation and generating a mark is in response to a user request.

Elements of musical notation can include, but are not limited to, notes, or parts of notes, such as note stems, note heads, note beams, quaver tails, symbols, or parts of symbols, such as flats, sharps, naturals, crotchet rests, bass clefs, treble clefs, barlines, slurs, lines, curves, hooks, leger lines, staff lines, time signatures, accidentals, articulations, dynamics.

Characteristics of the elements of musical notation can include, but are not limited to, a position on a musical staff, a spacing between an adjacent element, angle, length, alignment, points of intersection, start points, end points, ratios, relative size, name, quantity.

In another form, although again not necessarily the broadest form, the invention resides in a system for teaching and examining in the field of music, said system comprising:

a display to present a user with one or more musical tasks and a menu with one or more selectable icons;

an input device to allow the user to select the one or more selectable icons; and

a processor coupled to be in communication with the display and the input device to:

a) activate functionality to enable the user to form an element of musical notation with the input device in response to selection of one of said icons;

b) compare one or more characteristics of the element of musical notation with one or more predetermined thresholds; and

c) generate a mark based on the result of comparing the one or more characteristics of the element of musical notation with one or more predetermined thresholds.

Suitably, comparing the one or more characteristics of the element of musical notation and generating a mark is in response to a user request.

The system may further comprise a storage facility, such as a database coupled to be in communication with the processor to store the marks and/or the answers to the one or more musical tasks.

In a further form, although it need not be the only or indeed the broadest form, the invention resides in a method of examining in the field of music, said method including:

presenting a user with one or more musical tasks;

recording music performed by the user in response to the one or more musical tasks;

generating a mark based on the result of comparing the recorded music with one or more predetermined thresholds.

Suitably, the method includes presenting musical notation to the user to perform.

Suitably, the method includes presenting a tempo to the user at which the music must be performed, for example, via an audible periodic sound, such as metronome clicks.

Suitably, the method includes playing a backing track along to which the user is requested to play.

Suitably, the method includes re-presenting the user with at least part of the one or more musical tasks previously presented, but at a reduced tempo, where the user commits one or more errors in performing the one or more musical tasks.

Suitably, the method includes re-presenting the user with at least part of the one or more musical tasks previously presented, but at a tempo increased from the reduced tempo, where the user performs the one or more musical tasks correctly at the reduced tempo.

In yet another form, although it need not be the only or indeed the broadest form, the invention resides in a method of teaching and examining a subject, said method including:

generating a lesson for the subject from a store of components related to the subject;

presenting a user with the lesson comprising one or more tasks related to the subject;

providing a menu with one or more selectable icons, selection of one of said icons activating functionality to enable the user to submit one or more responses to the one or more tasks; and

generating a mark based on the result of comparing the one or more responses with one or more predetermined thresholds.

Preferably, the method includes presenting the user with a modified lesson comprising one or more tasks related to the subject previously answered incorrectly by the user.

Suitably, the method includes generating a lesson for duration of a learning period, such as for each week of an educational term or year.

Suitably, the tasks can be selected from the following: inputting a word in response to the word being audibly presented; inputting the result of an equation; inputting the name of a country in response to the display of a silhouette of a country; identifying a misspelt word and inputting the word correctly.

Further forms and features of the present invention will become apparent from the following detailed description.

### BRIEF DESCRIPTION OF THE DRAWINGS

By way of example only, preferred embodiments of the invention will be described more fully hereinafter with reference to the accompanying drawings, wherein:

FIG. 1 is a schematic representation of a system for teaching and examining in the field of music in accordance with an embodiment of the present invention;

FIG. 2 is a screenshot showing part of a lesson in accordance with an embodiment of the present invention;

FIGS. 3-5 are screenshots demonstrating the teaching and marking of drawing a crotchet rest;

FIG. 6 is a screenshot illustrating examining a user on the naming of a note;

FIG. 7 is a screenshot illustrating examining a user on the playing of the note in FIG. 6 visually and aurally;

FIGS. 8 and 9 are screenshots illustrating examining and marking a user on musical tasks requiring the drawing of multiple musical notation elements;

FIGS. 10-12 are screenshots illustrating examining and marking a user on the drawing of a sharp sign;

FIGS. 13-21 are further screenshots showing examining and marking musical tasks to be completed by users as exercises and/or examination questions;

FIG. 22 is a screenshot showing the display when a user has completed a lesson, exercise or practice examination;

FIG. 23 is a general flow diagram showing a method according to embodiments of the present invention;

FIGS. 24-27 are screenshots showing examining and marking a user on the playing of a piece of music according to other embodiments of the present invention;

FIG. 28 is a general flow diagram showing a method according to another embodiment of the present invention; and

FIG. 29 is a schematic diagram illustrating teaching and examining other subjects according to other embodiments of the present invention.

### DETAILED DESCRIPTION OF THE INVENTION

Like features in the drawings are referred to by like reference numerals.

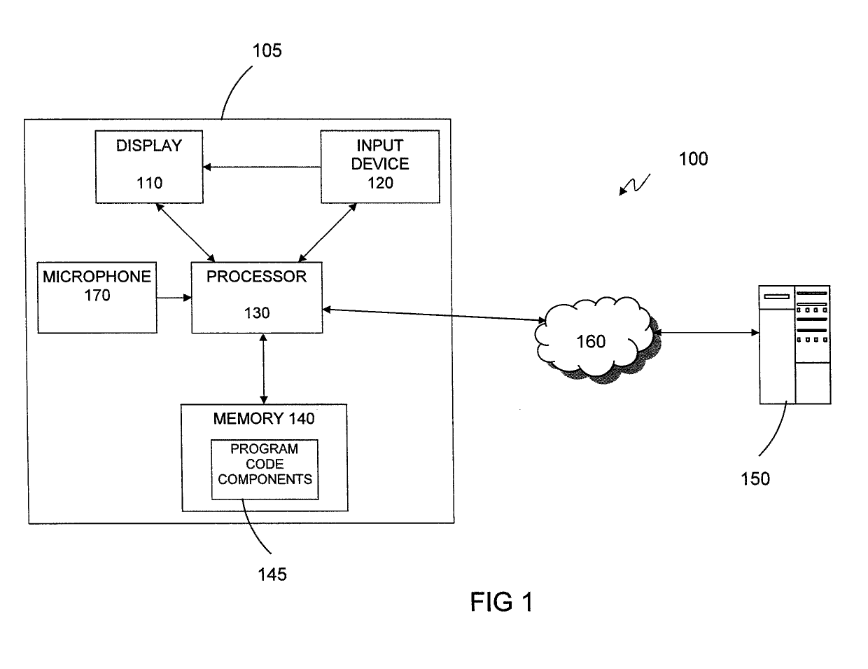

Referring to FIG. 1, there is provided a system 100 for teaching and examining in the field of music and other subjects in accordance with embodiments of the present invention. The system 100 comprises a display 110 and an input device 120, both of which are coupled to be in communication with a processor 130. Processor 130 is also coupled to be in communication with a memory 140. Display 110, input device 120, processor 130 and memory 140 can be embodied in an apparatus 105 in the form of a conventional computing device, such as a desktop, laptop or notebook computer, personal digital assistant (PDA) or other mobile computing device.

In accordance with embodiments of the present invention, display 110 is provided to present a user with one or more musical tasks and to present a menu with one or more selectable icons. Display 110 can be in the form of an integral screen or a separate monitor or the like and can be in the form of a touch sensitive screen. Input device 120, such as a keyboard, mouse, or a stylus that can be used in conjunction with a touch sensitive screen, is provided to allow the user to select the one or more selectable icons from the menu and generally navigate through the musical tasks. The processor 130 is provided to activate functionality stored in the memory 140 in the form of computer readable program code components 145 to enable the user to form elements of musical notation with the input device 120 in response to selection of one of the icons. The processor 130 is also provided to compare one or more characteristics of the element of musical notation with one or more predetermined thresholds in response to a user request, such as requesting marking of the task by selecting a suitable icon. The processor 130 generates a mark based on the result of comparing the one or more characteristics of the element of musical notation with one or more predetermined thresholds and the mark can be displayed to the user via display 110 to promptly provide feedback to the user.

Another form of input device can be in the form of a microphone 170 for capturing sound, which can be stored in memory 140 after processing by processor 130 and optionally by a dedicated audio processor (not shown). For example, for the teaching and examining of music, microphone 170 captures music performed by the user in response to one or more musical tasks presented to the user. For the teaching and examining of other subjects, such as languages, microphone 170 captures language spoken by the user, for example to measure the user's linguistic competency. Microphone 170 can be integral to or separate from the apparatus 105. These embodiments will be described in more detail hereinafter.

According to some embodiments, the system 100 can further comprise a storage facility 150, such as a database, optionally associated with a server, coupled to be in communication with the processor 130 via conventional communications hardware and software to store the marks of the lessons/examinations for each user. The storage facility 150 can be coupled to the processor 130 locally or via a communications network 160, for example, a local area network (LAN), a wide area network (WAN) or combination thereof, or a global communication network, such as the Internet. Communication between the processor 130 and the storage facility 150 can be wired or wireless or a combination thereof.

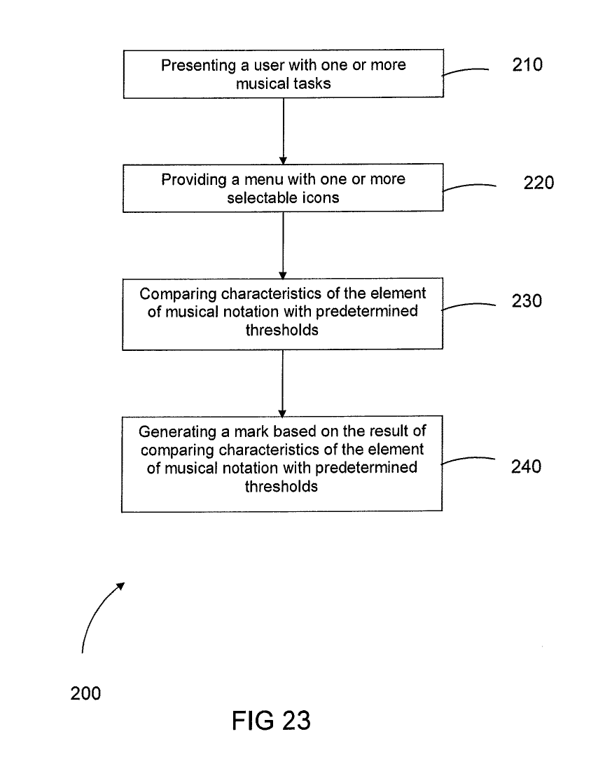

With reference to the general flow diagram shown in FIG. 23, a method 200 for teaching and examining music includes at 210 presenting a user with one or more musical tasks, such as, but not limited to drawing a musical scale, identifying notes or completing a melody. At 220, the method includes, providing a menu with one or more selectable icons, selection of one of said icons activating functionality to enable the user to form an element of musical notation. The method includes at 230 comparing one or more characteristics of the element of musical notation with one or more predetermined thresholds to verify whether the user has completed the musical task correctly. At 240, generating a mark based on the result of comparing the one or more characteristics of the element of musical notation with one or more predetermined thresholds.

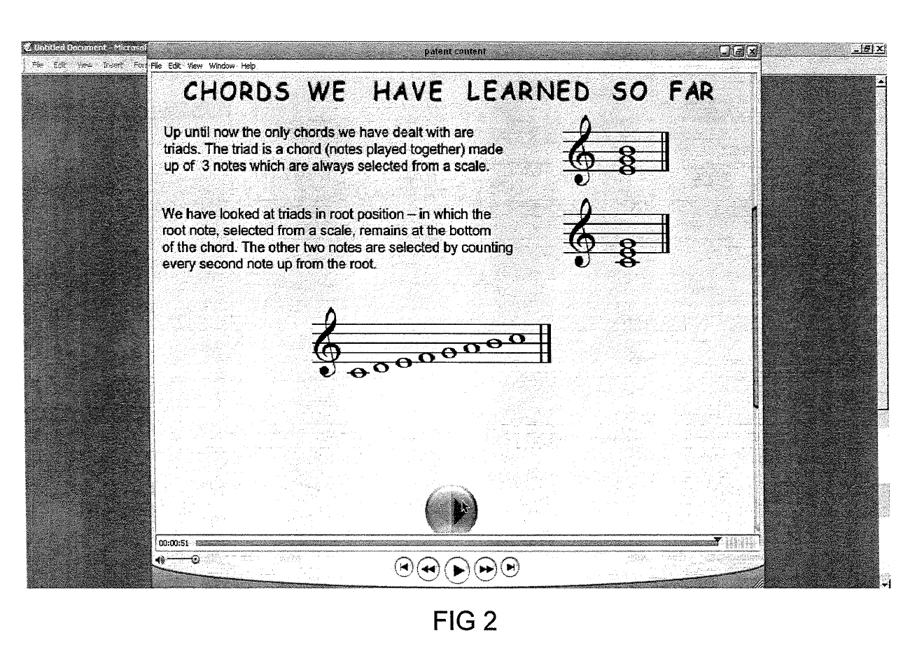

Examples of teaching and examining in the field of music in accordance with embodiments of the present invention will now be described with reference to the screenshots in FIGS. 2-22.

Referring to FIG. 2, the screenshot shows part of a lesson comparable with how the lesson would be conveyed to a user or student by the prior art in that a chord is displayed with a description of its composition. However, in contrast to the prior art, one of the benefits of the present invention is that it includes animation and can visually demonstrate formation of the chord from the individual notes. Another benefit of the present invention is that the individual notes and the chord can be played and heard by the user, thus providing a major advantage over the conventional paper methods of teaching music.

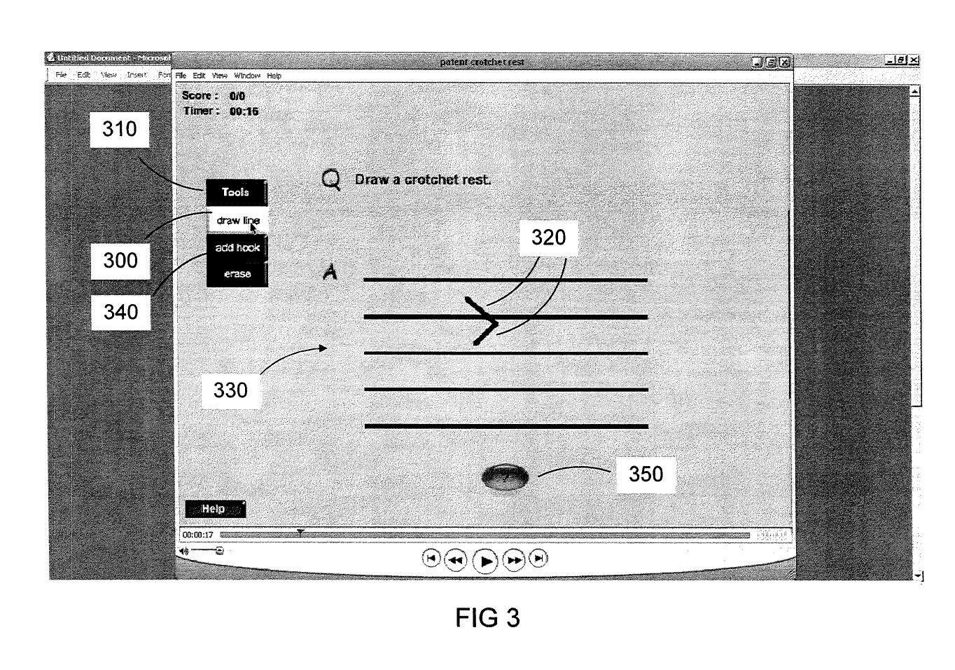

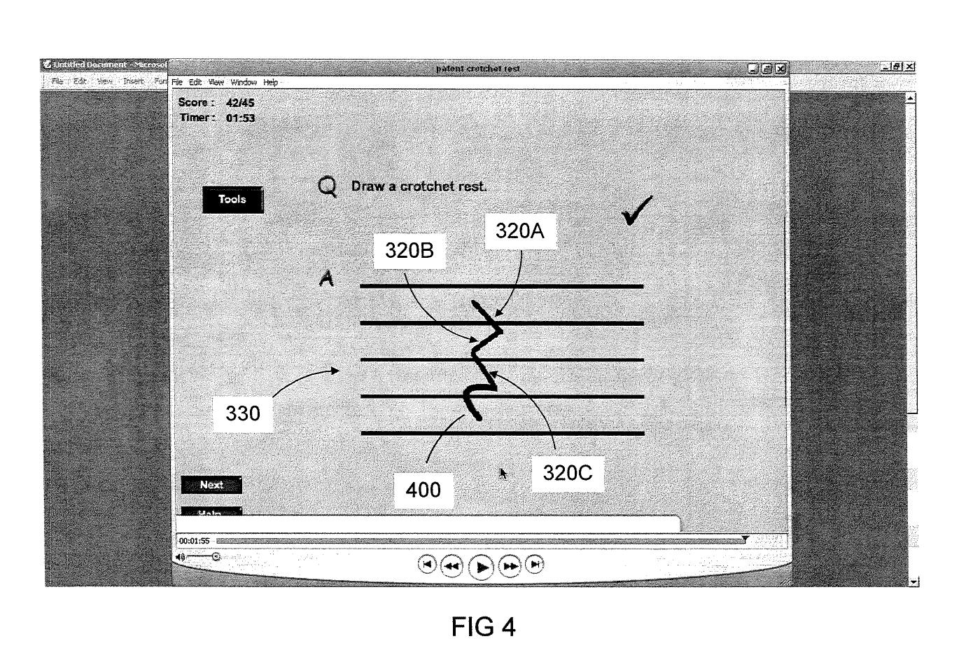

Referring to FIGS. 3-5, the screenshots shows embodiments of the present invention teaching and examining the drawing of musical notation in the form of a crotchet rest by a user and the marking of the user's work. The user is presented with a musical task, which in this example is to “Draw a crotchet rest”. The user selects the “draw line” icon 300 from the drop down menu 310 on the screen and draws three individual lines 320 with the input device 120, such as a mouse, on the staff 330 provided on the screen. FIG. 3 shows two of the lines 320 that have been drawn. The user then selects the “add hook” icon 340 from the drop down menu 310 and uses a drag and drop method to add the hook 400 shown in FIG. 4 to the end of the third line 320C to produce the crotchet rest. The user can adjust the beginning or start points, end points and the shape of the hook with the input device 120.

Pressing the marking button 350 informs the user as to whether the crotchet rest has been drawn correctly, which it has been in the example shown in FIG. 4. The software checks characteristics of the elements of musical notation including the angles, beginning and end points of each line 320, the intersection points of each line and the beginning and end positions of the hook 400 by comparing the characteristics of the elements of musical notation with corresponding predetermined thresholds. The software checks the beginning point of the top line 320A of the crotchet rest and the direction of the top line. An example of suitable program code components for performing this function follow:

```
on checkline1
  --sprite(4).top − sprite(81).top+20 < 9 top point first line correctly
  placed
  if abs(sprite(4).top − sprite(81).top+24.5) < 9 and
sprite(81).member.linedirection = 0 then append (answerList, “a”)
end
```

The software checks the beginning point of the second line 320B where it joins to the end of the first line 320A of the crotchet rest and the direction of the second line 320B. An example of suitable program code components for performing this function follow:

```
on checkline2
  --2nd joint in right spot
  if abs(sprite(4).top − sprite(82).top+61.25) < 9 and
sprite(82).member.linedirection = 1 then append (answerList, “b”)
end
```

The software checks the beginning point of the third line 320C where it joins to the end of the second line 320B of the crotchet rest and the direction of the third line. An example of suitable program code components for performing this function follow:

```
on checkline3
  --3rd joint in right spot
  if abs(sprite(4).top − sprite(83).top+85.75) < 9 and
sprite(83).member.linedirection = 0 then append (answerList, “c”)
end
```

The software checks the beginning point of the hook 400 where it joins the third line 320C of the crotchet rest and the direction of the hook. An example of suitable program code components for performing this function follow:

```
on checkline4
  --4th joint in right spot
  if abs(sprite(4).top − sprite(83).bottom+134.75) < 9 and
sprite(83).member.linedirection = 0 then append (answerList, “d”)
end
```

The software checks the end point of the hook 400 where it finishes at the bottom of the staff 300 on the screen. An example of suitable program code components for performing this function follow:

```
on checkhook
  if sprite(112).puppet = false then exit
  if sprite(83).member.linedirection = 0 then a = 3
  if sprite(83).member.linedirection = 1 then a = 4
  dx= sprite(112).loch − sprite(83).quad[a].loch
  dy = sprite(112).locv − sprite(83).quad[a].locv
  ans = sqrt (power(dx,2) + power(dy,2) )
  dx1= sprite(113).loch − sprite(83).quad[a].loch
  dy1 = sprite(113).locv − sprite(83).quad[a].locv
  ans1 = sqrt (power(dx1,2) + power(dy1,2) )
  if ans1 > ans then b = 113
  if ans1 < ans then b = 112
  if abs(sprite(4).top − sprite(b).locv +171.5) < 9 then append
(answerList, “f”)
end
```

The software checks the length of each line 320A, 320B, 320C, the vertical alignment of the beginning point of the first line 320A and the end point of second line 320B, the vertical alignment of the beginning point of the second line 320B and the end point of the third line 320C, the vertical alignment of the beginning point of the hook and the end point of hook 400. The software also checks the angle of each line. If the angle of each line is correct, a tick appears on the screen, as shown in FIG. 4. Conversely, if the angle of between the lines are incorrect, the comment “______ line too wide.” or “______ line too narrow.” appears on the screen. An example of suitable program code components for performing these functions is as follows:

```
on checkangleline3
  if sprite(83).member.linedirection = 0 then
    dx= sprite(83).quad[1].loch − sprite(83).quad[3].loch
    dy = sprite(83).quad[1].locv − sprite(83).quad[3].locv
    a= atan ( float(dy) /float (dx)) * 180 /pi
    put a
  end if
  if sprite(83).member.linedirection = 1 then
    dx= sprite(83).quad[2].loch − sprite(83).quad[4].loch
    dy = sprite(83).quad[2].locv − sprite(83).quad[4].locv
    a= atan ( float(dy) /float (dx)) * 180 /pi
    put a
  end if
  if sprite(83).member.linedirection = 0 and abs (a −45) < 10 then append
(answerList, “k”)
  if sprite(83).member.linedirection = 0 and a −45 < −10 then
member(“commentI”).text = member(“commentI”).text &&“Bottom
line too wide.”
  if sprite(83).member.linedirection = 0 and a −45 > 10 then
member(“commentI”).text =member(“commentI”).text && “Bottom
line too narrow.”
end
```

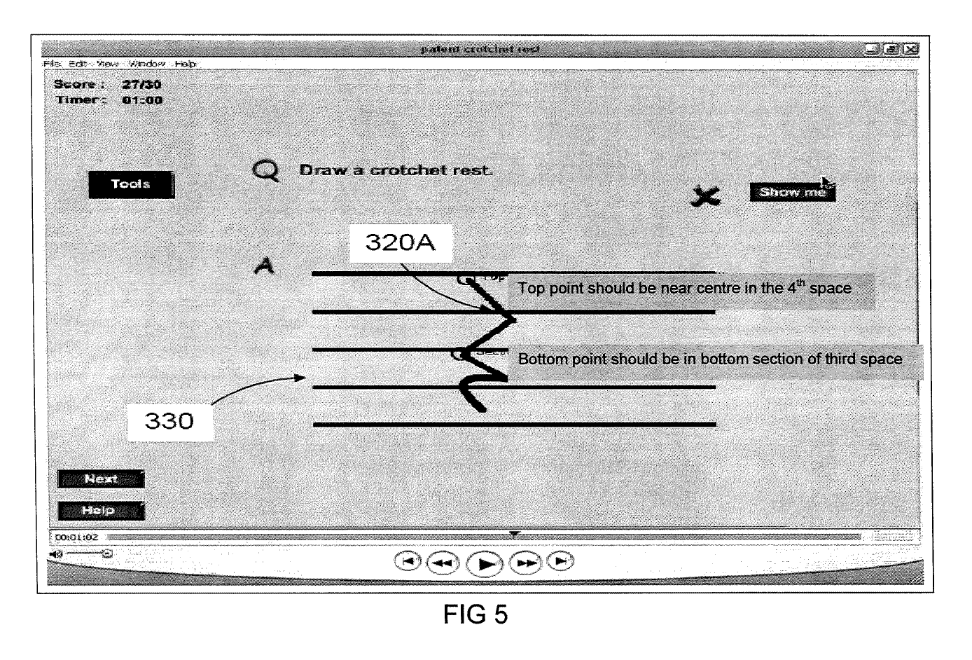

As shown in FIG. 5, elements of the crotchet rest that have been drawn incorrectly by the user are highlighted after marking has been requested to provide immediate feedback to the user thus enabling the user to learn from their mistakes. In the example in FIG. 5, the user is informed that the beginning of the first line 320A should be near the centre in the 4^{th} space of the staff 330 and the second join between the second and third lines 320B, 320C should be in the bottom section of the third space.

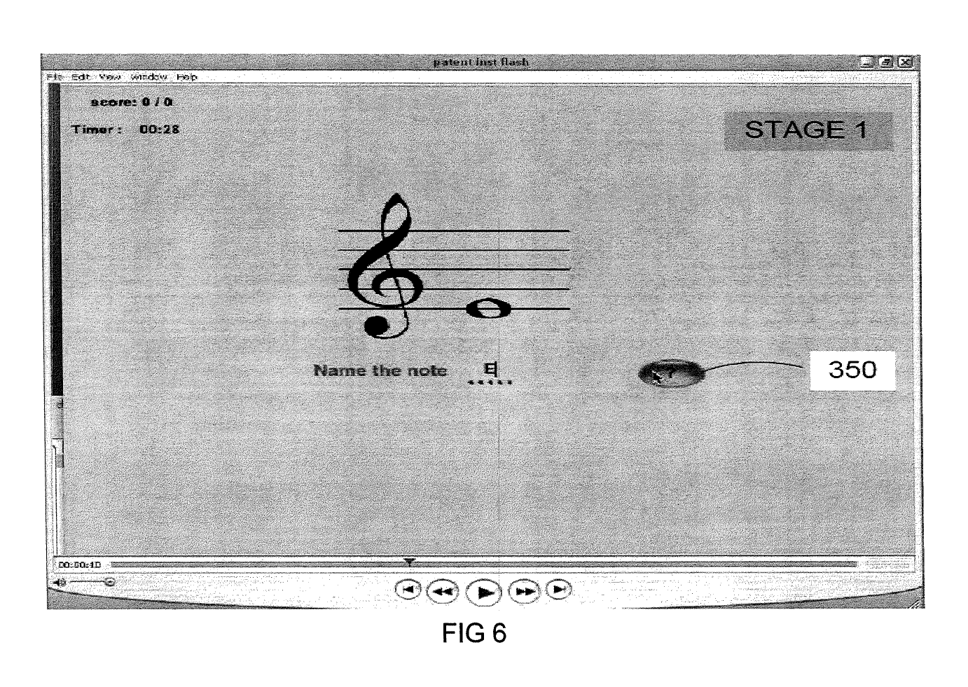

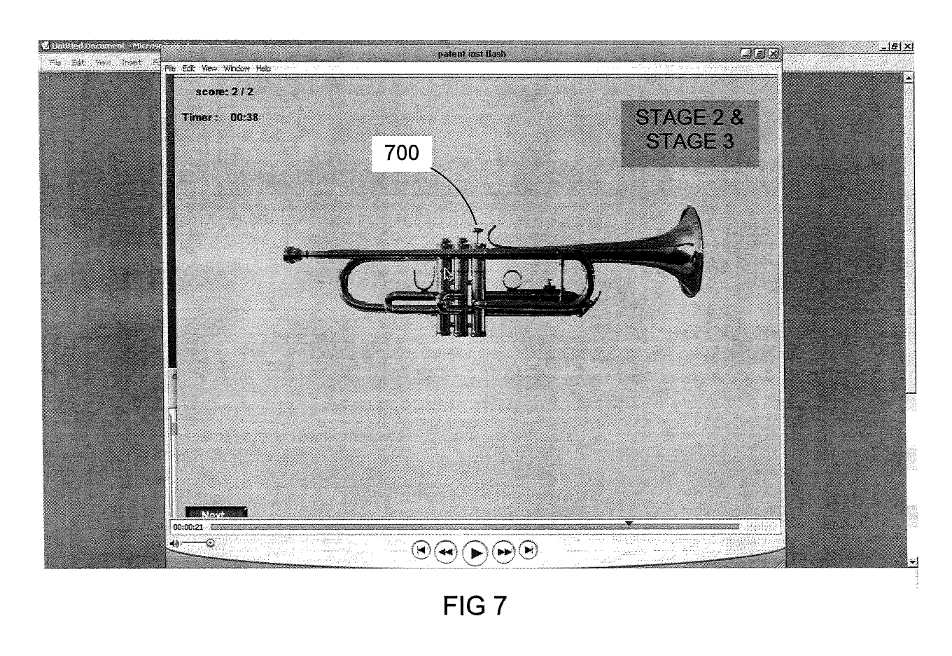

FIGS. 6 and 7 relate to a two-stage musical task where the user must name the note displayed in stage 1 and select appropriate keys, valves, buttons etc. of an instrument in stage 2. Upon the user requesting marking by selecting the question mark icon 350, the user is informed whether their answer is correct or incorrect. According to one embodiment, if the user is correct they receive a point and move to stage 2. If the user is incorrect they loose a point and repeat the question until they are correct.

With reference to FIG. 7, an image of an instrument chosen by the user appears on screen in stage 2. The user has to click on all the correct keys, e.g. for a piano, or valves 700 for the trumpet shown in FIG. 7, for the note from stage 1, to be played on that instrument. For every incorrect key, valve or button chosen, the user looses a point. When the user selects the correct keys, valves etc., they move to stage 3.

In stage 3, an animation of the instrument playing the note, visually and aurally, is displayed and played to the user. The user then selects the next button and an instrumental music flash program randomly selects a note and the process is repeated again. According to some embodiments, when all the notes have been selected, the user's results are transmitted to the database 150 where the user's progress can be monitored, for example, by a tutor. Monitoring can occur in real time as the user conducts the lesson or examination or at a later stage. Instrumental music flash can be used for all musical instruments and is used to correlate the recognition of the name of the note, fingers used to play the note and the pitch of the note.

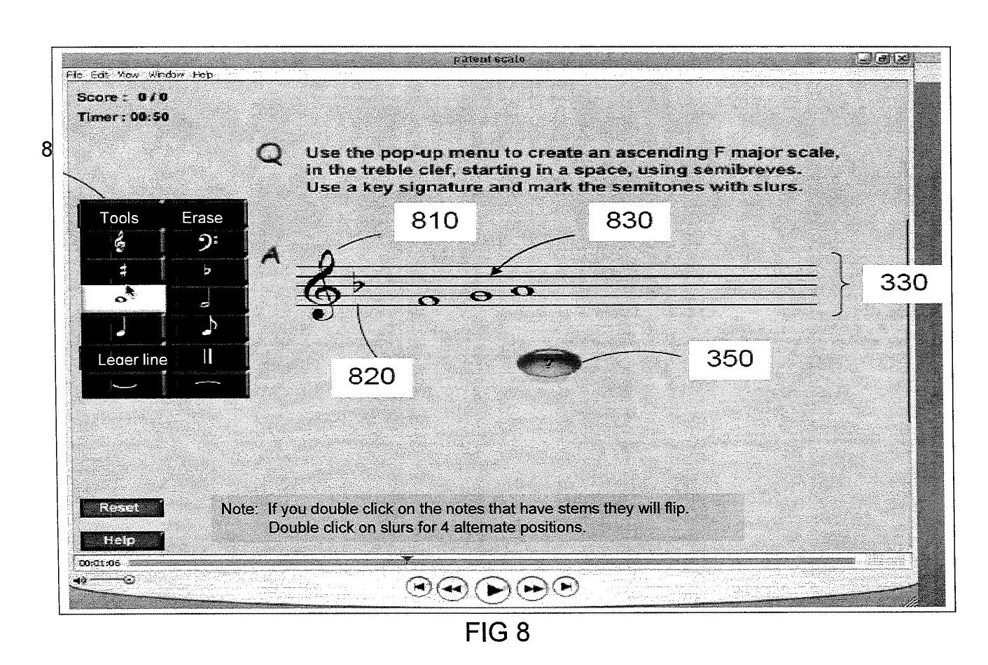

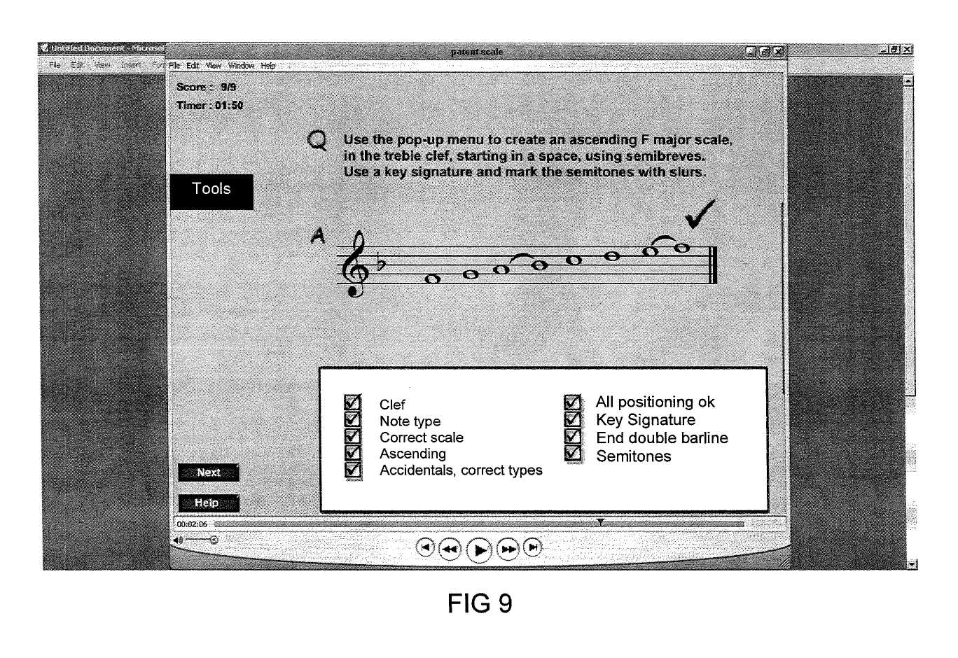

With reference to FIGS. 8 and 9, multiple elements of musical notation will be used in, for example, scales, transpositions, interval, melody writing, writing harmony, and in any musical exercise where more than one musical symbol needs to be checked. In this example, the musical task requires the user to create an ascending F major scale using semibreves.

The user selects the appropriate clef from the clef popup menu within the drop down menu 800 and places it on the staff 330 displayed on the screen using the drop and drag method. The user then selects the appropriate “draw line” and/or “draw curve” icons from the clef menu using the drop and drag method followed by the note heads. The user then selects the “draw curve line” icon from the articulation popup menu within the drop down menu to draw a slur and uses the input device 120 to draw the slur in the appropriate place. The user selects the “draw stem” icon from the drop down menu and draws the stems in the appropriate place using the input device 120. The user selects the “end bar line” icon from the drop down menu and uses the drop and drag method to place the end bar line in the appropriate place. These elements of musical notation can be selected in any order and when complete, the user selects the ‘marking’ button 350 to effect marking of the task and check if the question has been answered correctly. The screenshot in FIG. 8 shows the treble clef 810, a flat symbol 820 and three note heads 830 already drawn.

To mark the user's answer, the software sorts the note heads 830 in order from left to right as they appear in the staff 330 on the screen. This prepares the notes to be checked to verify whether the correct notes have been used. In other embodiments, the notes could be sorted in order from right to left. Suitable program code components for performing this function follow:

```
on sorthorizontal
  notesH=[ ]
  notesV=[ ]
  memberlist =[ ]
  repeat with sp in barnote
    if sprite(sp).puppet = 1 then append ( notesH, sprite(sp).locH)
    if sprite(sp).puppet = 1 then append (notesV, sprite(sp).locv)
    if sprite(sp).puppet = 1 then append (memberlist, sprite(sp).member)
  end repeat
  repeat with sp in barnote
    if sprite(sp).puppet = 1 then sprite(sp).locH = min (notesH)
    if sprite(sp).puppet = 1 then sprite(sp).locv = getat (notesV, getpos
(notesH,min (notesH)))
    if sprite(sp).puppet = 1 then sprite(sp).member = getat (memberlist,
getpos (notesH,min (notesH)))
    if sprite(sp).puppet = 1 then a = getpos (notesH,min (notesH))
    if sprite(sp).puppet = 1 then deleteat (notesH, a)
    if sprite(sp).puppet = 1 then deleteat (notesV, a)
    if sprite(sp).puppet = 1 then deleteat (memberlist, a)
  end repeat
  updatestage
end
```

The software then finds all the stems used with, for example, the follow code:

```
on makestemlist
  stemsprite = [ ]
  repeat with sp = 131 to 140
    if sprite sp intersects 41 then append (stemsprite, sp)
  end repeat
end
```

The software sorts the stems in order from left to right as they appear in the staff 330 on the screen. This prepares the stems to be associated with the equivalent note head, so each note can be marked as correct or incorrect. Suitable program code components for performing this function follow:

```
on sorthorizontalstems
  linesH=[ ]
  linesV=[ ]
  sizeline = [ ]
  memberlist = [ ]
  repeat with sp in stemsprite
    if sprite(sp).puppet <> 0 then append ( linesH, sprite(sp).locH)
    if sprite(sp).puppet <> 0 then append (linesV, sprite(sp).rect)
    if sprite(sp).puppet <> 0 then append (sizeline, sprite(sp).linesize)
    if sprite(sp).puppet <> 0 then append (memberlist, sprite(sp).member)
  end repeat
  repeat with sp in stemsprite
    if sprite(sp).puppet <> 0 then sprite(sp).locH = min (linesH)
    if sprite(sp).puppet <> 0 then sprite(sp).rect = getat (linesV, getpos
(linesH,min (linesH)))
    if sprite(sp).puppet <> 0 then sprite(sp).linesize = getat (sizeline,
getpos (linesH,min (linesH)))
    if sprite(sp).puppet <> 0 then sprite(sp).member = getat (memberlist,
getpos (linesH,min (linesH)))
    if sprite(sp).puppet <> 0 then a = getpos (linesH,min (linesH))
    if sprite(sp).puppet <> 0 then deleteat (linesH, a)
    if sprite(sp).puppet <> 0 then deleteat (linesV, a)
    if sprite(sp).puppet <> 0 then deleteat (sizeline, a)
    if sprite(sp).puppet <> 0 then deleteat (memberlist, a)
  end repeat
  updatestage
end
```

The software checks whether the notes are in the correct position and whether the correct spacing between the notes has been used by comparing these characteristics with predetermined thresholds for the respective characteristics of the elements of musical notation. Suitable program code components for performing this function follow:

```
on checkbassnotes
  SpriteStaffNo = 2
  notesinlistLtoR = [ ]
  repeat with k = 0 to span
    n = startsprite + k
    if  sprite(n).loch > sprite(SpriteStaffNo).left and
sprite(n).loch < sprite(SpriteStaffNo).right and
abs(sprite(SpriteStaffNo).rect[4] -
sprite(n).locv − 36 ) <2 then notesinlistLtoR.append(“g3”)
    if  sprite(n).loch > sprite(SpriteStaffNo).left and
sprite(n).loch < sprite(SpriteStaffNo).right and
abs(sprite(SpriteStaffNo).rect[4] -
sprite(n).locv − 30 ) <2 then notesinlistLtoR.append(“f3”)
    if  sprite(n).loch > sprite(SpriteStaffNo).left and
sprite(n).loch < sprite(SpriteStaffNo).right and
abs(sprite(SpriteStaffNo).rect[4] -
sprite(n).locv− 24 ) < 2 then notesinlistLtoR.append(“e3”)
    if  sprite(n).loch > sprite(SpriteStaffNo).left and
sprite(n).loch < sprite(SpriteStaffNo).right and
abs(sprite(SpriteStaffNo).rect[4] -
sprite(n).locv − 18 ) < 2 then notesinlistLtoR.append(“d3”)
    if  sprite(n).loch > sprite(SpriteStaffNo).left and
sprite(n).loch < sprite(SpriteStaffNo).right and
abs(sprite(SpriteStaffNo).rect[4] -
sprite(n).locv −12 ) < 2 then notesinlistLtoR.append(“c3”)
    if  sprite(n).loch > sprite(SpriteStaffNo).left and
sprite(n).loch < sprite(SpriteStaffNo).right and
abs(sprite(SpriteStaffNo).rect[4] -
sprite(n).locv − 6 ) < 2 then notesinlistLtoR.append(“b2”)
    if  sprite(n).loch > sprite(SpriteStaffNo).left and sprite(n).loch <
sprite(SpriteStaffNo).right and sprite(n).member <> member 10 of
castLib 1 and abs(sprite(SpriteStaffNo).rect[4] - sprite(n).locv ) < 2 then
notesinlistLtoR.append(“a2”)
    if  sprite(n).loch > sprite(SpriteStaffNo).left and sprite(n).loch <
sprite(SpriteStaffNo).right and abs(sprite(SpriteStaffNo).rect[4] -
sprite(n).locv +6 ) < 2 then notesinlistLtoR.append(“g2”)
    if  sprite(n).loch > sprite(SpriteStaffNo).left and sprite(n).loch <
sprite(SpriteStaffNo).right and abs(sprite(SpriteStaffNo).rect[4] -
sprite(n).locv +12 ) < 2 then notesinlistLtoR.append(“f2”)
  end repeat
end
```

The software checks for any accidental used as stated in drawing sharps, flats and naturals elsewhere in this document. The software checks for any other variables in a multi symbol question. All the above checks must be deemed correct within the thresholds of the software for the question using multiple symbols to be correct. Marks are added to the running total for each element of musical notation or characteristic thereof that the software checks and which is within the thresholds to be marked correct. In FIG. 9, all the tasks were correctly completed by the user.

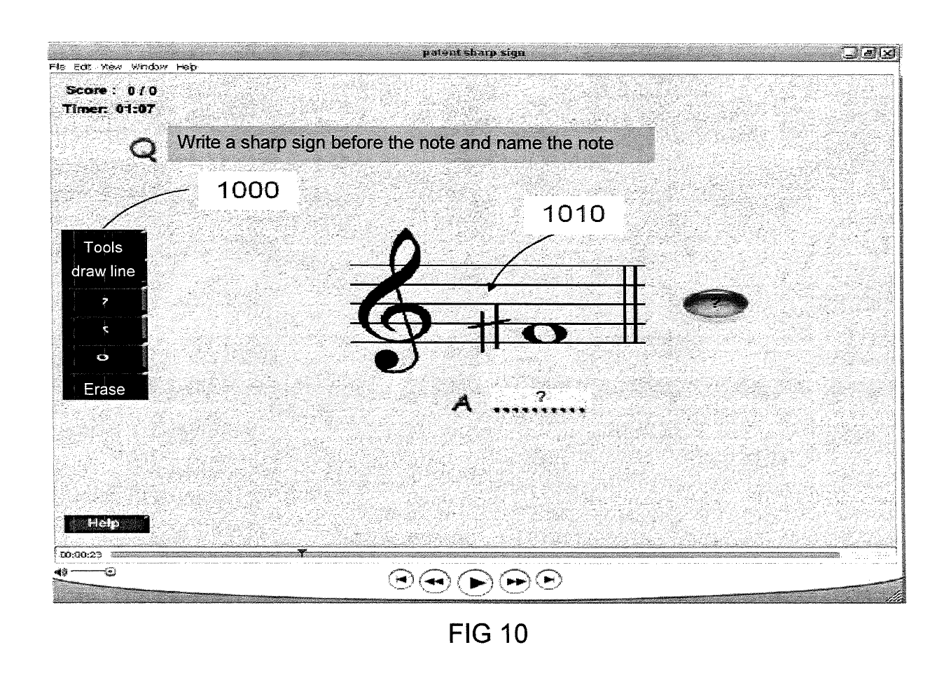

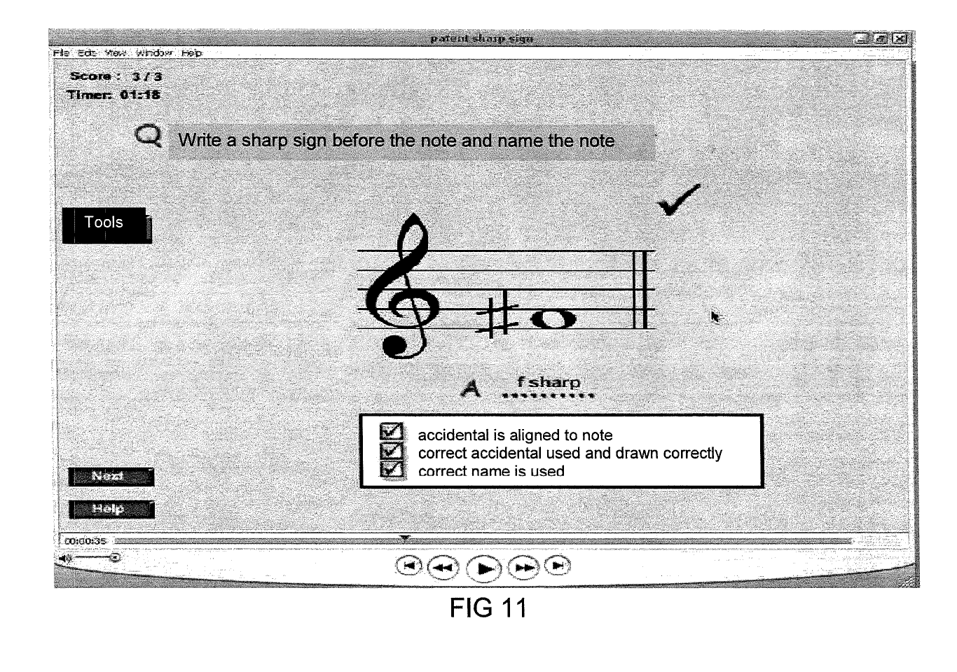

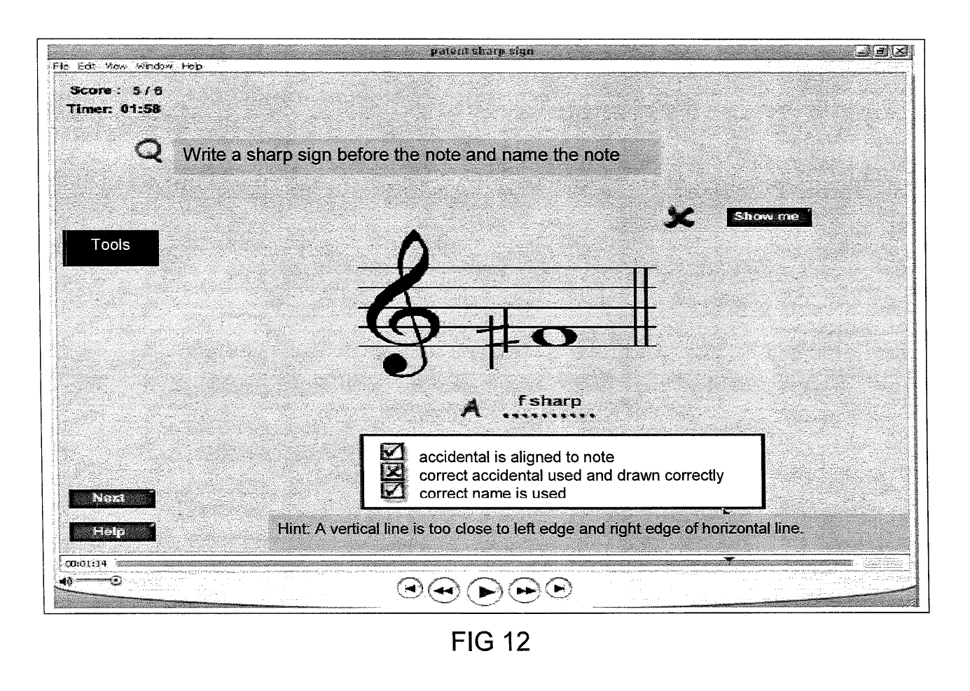

FIGS. 10-12 are screenshots illustrating teaching and marking the drawing of a sharp sign. FIG. 10 shows the menu 1000 used to draw the sharp sign 1010, which is partially drawn in FIG. 10. FIG. 11 shows the completed task in which all the measured characteristics of the elements of musical notation have been drawn and positioned correctly. Each of the assessed characteristics is shown, which include verifying that the accidental is aligned to the note, the correct accidental has been used and drawn correctly and the note and the accidental have been named correctly. FIG. 12 shows the measured characteristics of the elements of musical notation that have been drawn correctly and incorrectly. Whilst the accidental is aligned to the note and the note has been named correctly, the accidentals are not drawn correctly. Hints can also be provided to educate the user where they made mistakes. Hence, feedback to the student is immediate and they can improve on their earlier performance.

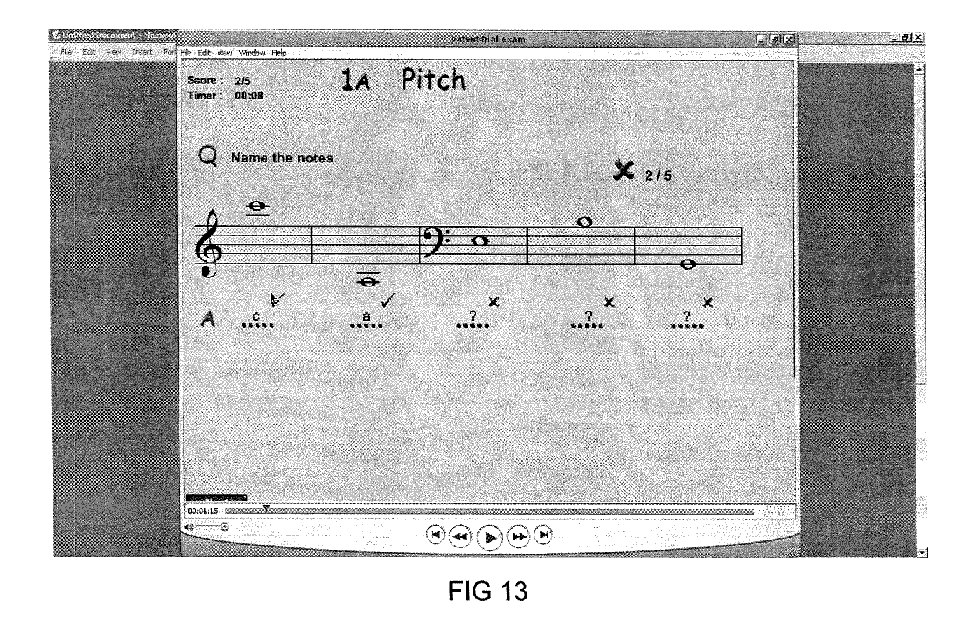

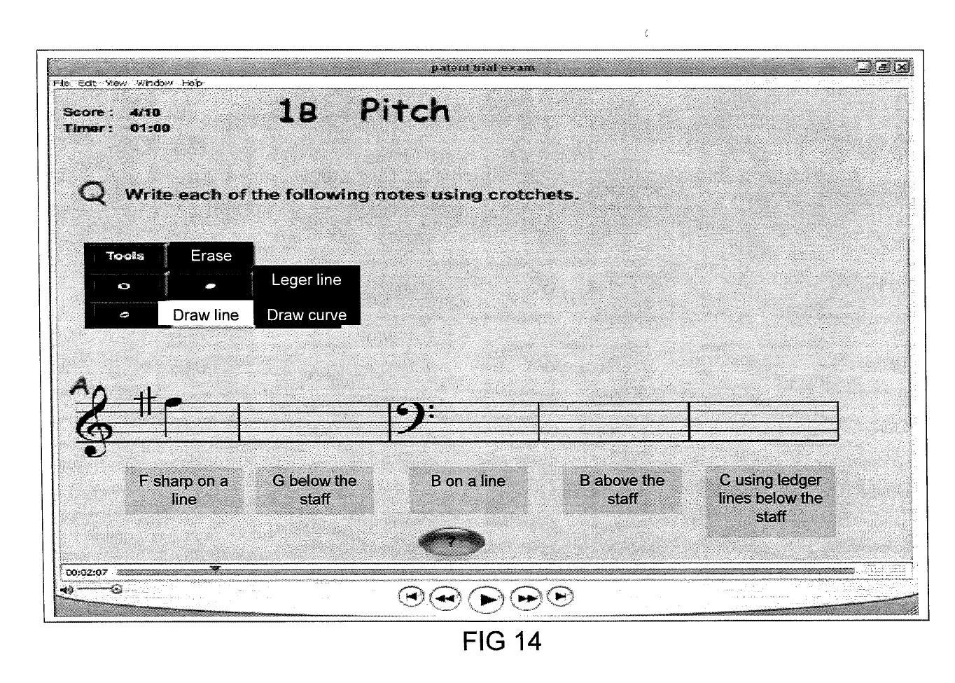

FIGS. 13-21 show further screenshots illustrating embodiments of the present invention teaching and examining musical tasks to be completed by users as exercises and/or examination questions. For example, FIG. 13 shows a musical task in which the user must name the notes as part of a pitch exercise, whereas in FIG. 14, the user must draw the notes using crotchets. An example of program code components that enable the user to draw the elements of musical notation for these examples follows:

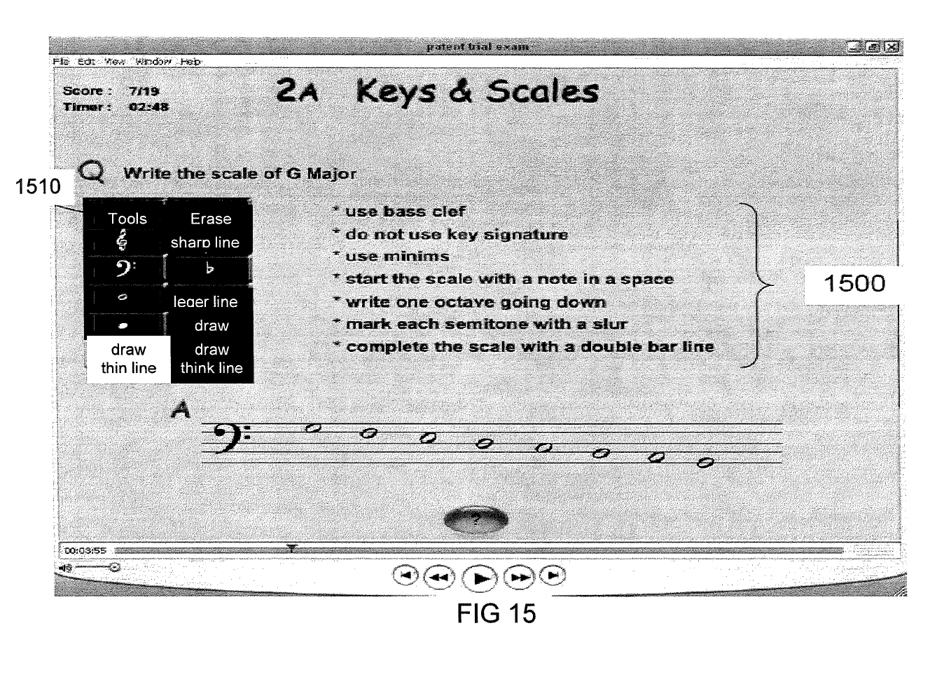

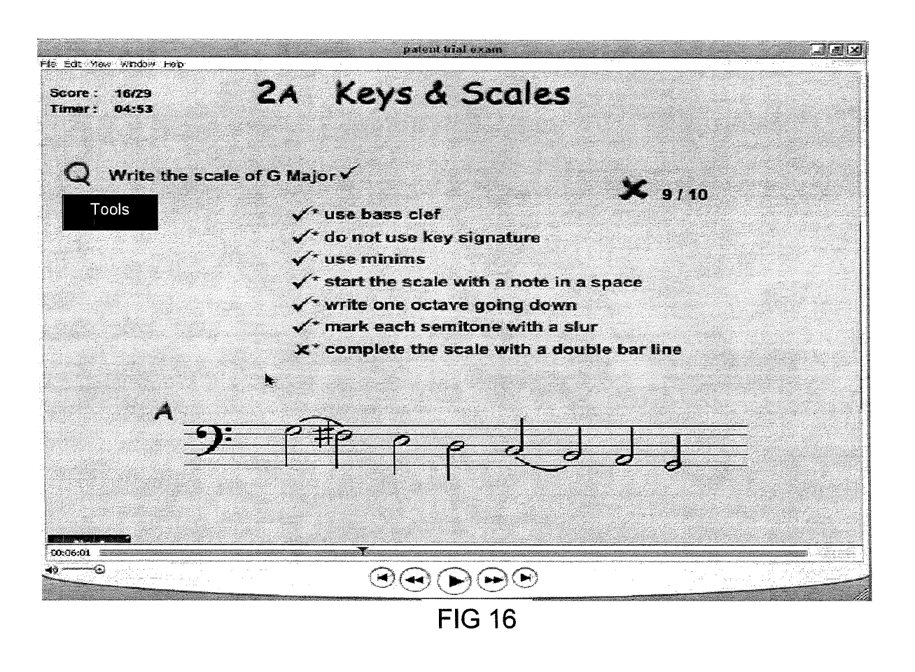

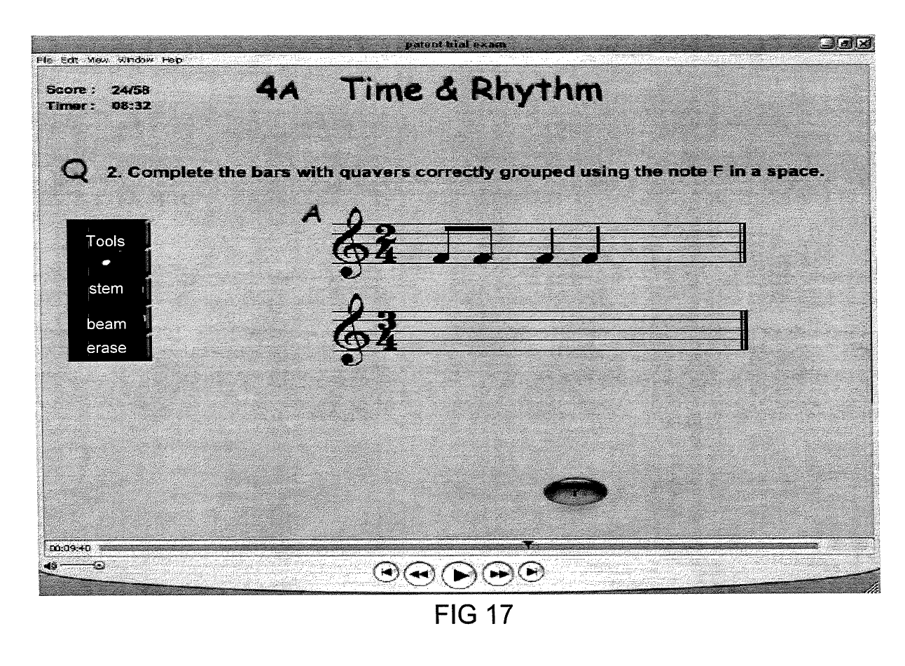

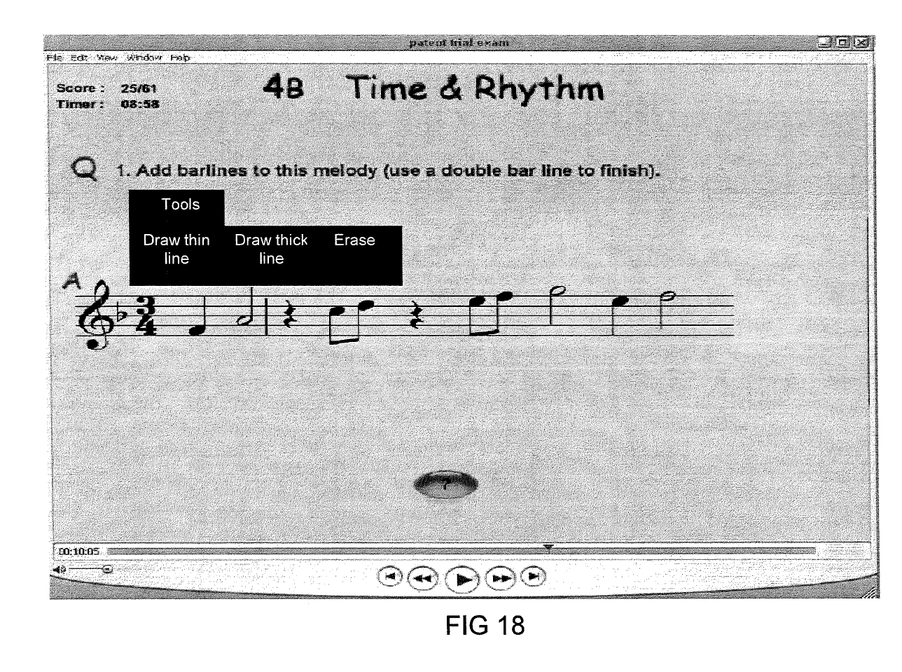

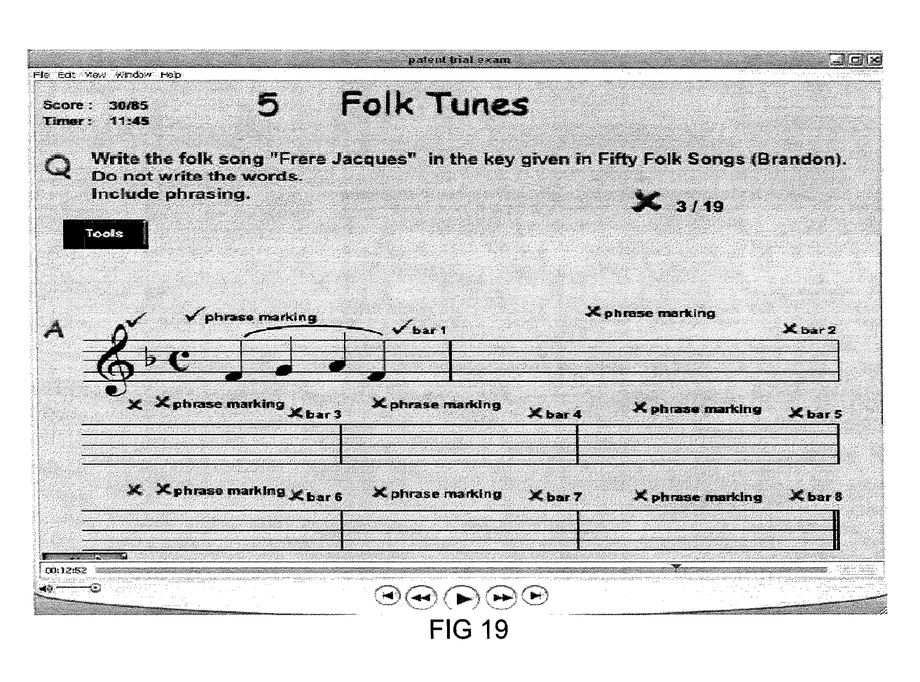

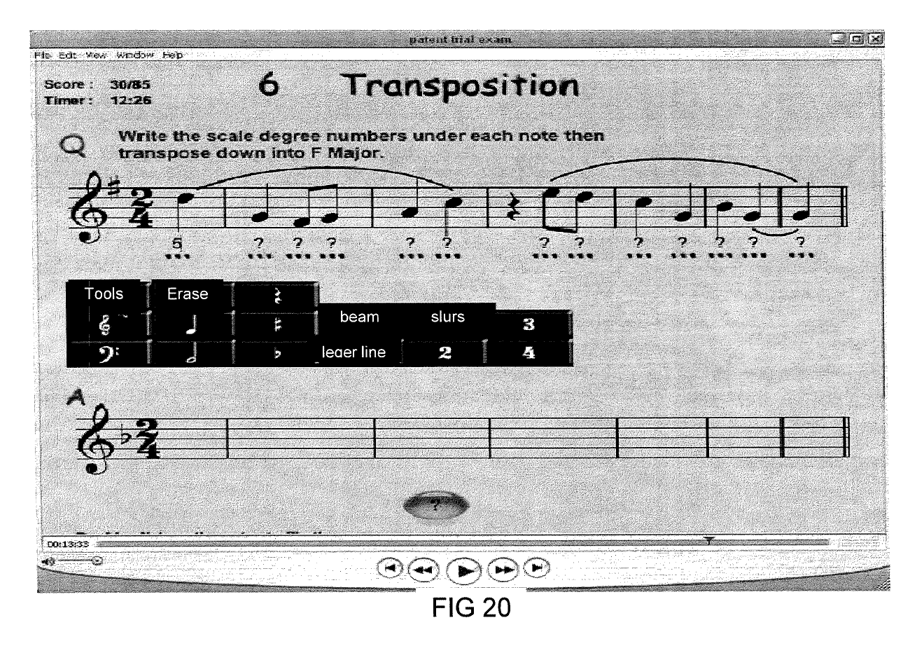

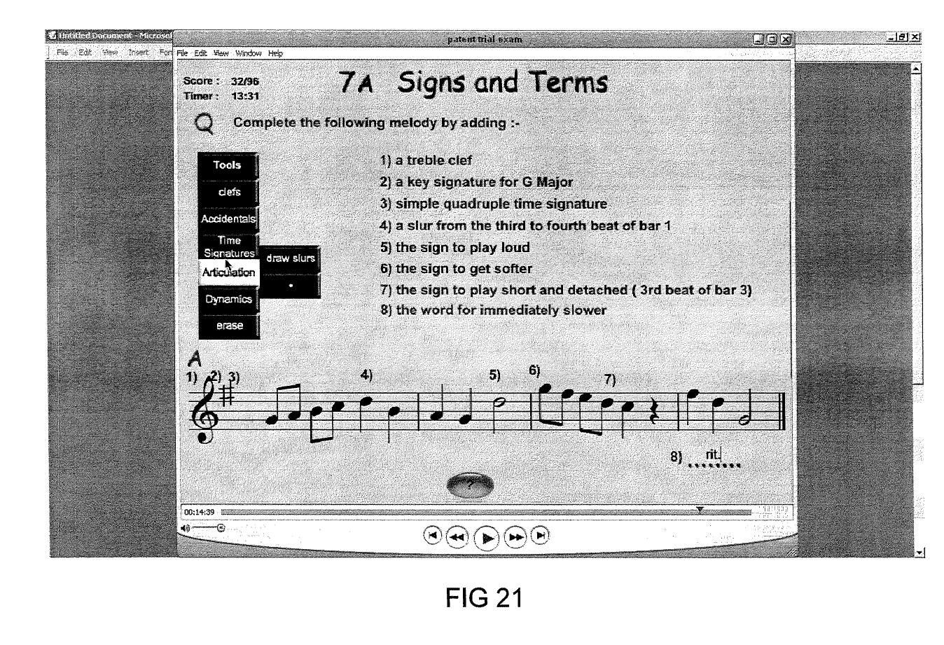

FIGS. 15 and 16 illustrate a keys and scales task in which the scale of G Major must be drawn according to the instructions 1500 displayed. The menu 1510 is shown in FIG. 15 providing all the icons necessary to complete the musical task and the result of marking is shown in FIG. 16. In this example, the user did not complete the scale with a double bar line and their mark is 9/10. Time and rhythm tasks are shown in FIGS. 17 and 18 and in the task shown in FIG. 19 a folk song memorised by the user must be written according to the instructions. A transposition task is shown in FIG. 20 and signs and terms are tested in FIG. 21. For each task, the appropriate menu is displayed, with sub-menus where required, to enable the user to draw the musical notation using elements thereof or to enable the user to insert the required musical notation depending on the aspect of music theory being taught and/or examined.

Embodiments of the present invention also enable users to draw flat signs 820, an example of which is shown in FIG. 8. The user draws a line with the input device 120 onto the music staff 330 provided on the screen by selecting the ‘draw line’ icon from the drop down menu. The user draws a curved line with the input device 120 onto the music staff attaching it to the straight line already drawn by selecting the ‘draw curve line’ from the drop down menu on the screen. When complete, the user selects the ‘marking’ button 350 to see if the flat has been assembled correctly.

The software checks the angle, position and size of the flat sign 820 in relation to the staff 330 and the note on the staff, by comparison with predetermined thresholds. The horizontal position of the flat sign is determined by its left-right relation to the staff. If its position is incorrect, an on-screen message appears, alerting the user to the error. The software checks that only one line has been drawn, suitable program code components for which are as follows:

```
--check for stems in bar 1
  stemsprite = [ ]
  repeat with r = 131 to 159
    if sprite r intersects 41 then append (stemsprite, r)
  end repeat
  --check only one line for flat
  if stemsprite.count<>1 then
    markcross
    exit
  end if
```

The software checks the angle of the line that has been drawn. If the line of the flat is at the correct angle, a tick appears on the screen. Conversely, if the line of the flat is at an incorrect angle, the comment “flat stem is straight” appears on the screen, suitable program code components for which are as follows:

```
if sprite(flatlinesp).width > 7 then
  markcross
  exit
end if
```

The software checks the length of the flat line that has been drawn. If the line of the flat is the correct length, a tick appears on the screen. Conversely, if the line of the flat is not the correct length, the comment “flat stem length is incorrect length” appears on the screen effected by the following suitable program code components:

```
if abs(sprite(flatlinesp).height − 31 ) > 6 then
  markcross
  exit
end if
put “flat stem is incorrect length”
```

The software then finds the end points of the flat curve and checks where they intersect the straight line of the flat. If the curve line intersects the straight line, a tick appears on the screen. Conversely, if one or both points of the curved line of the flat do not intersect the straight line, a cross appears on the screen effected by the following suitable program code components:

```
--find endpoints of curve
flatpoints = [ ]
repeat with r in [191,193,194,196]
  if sprite r intersects 41 then append (flatpoints, r)
  end repeat
  if flatpoints.count <> 2 then
    markcross
    exit
  end if
  put “2 points”
  if sprite(flatpoints[1]).locv > sprite(flatpoints[2]).locv then
    topcurvept = flatpoints[2]
    bottomcurvept =flatpoints[1]
  else
    topcurvept = flatpoints[1]
    bottomcurvept =flatpoints[2]
  end if
  --check bottom end of flat stem = 18
  if abs(sprite(flatlinesp).bottom - sprite(2).bottom +14) > 4 then
    markcross
    exit
  end if
  put “bottom correct”
  --top of flat curve lines up with 32
  if abs(sprite(topcurvept).top - sprite(2).bottom +32) > 4 then
    markcross
    exit
  end if
    put “top correct”
  --bottom flat curve to bottom flat stem
  if sprite(flatlinesp).member.linedirection = 0 then
    if abs(sprite(flatlinesp).quad[3].locv -
sprite(bottomcurvept).locv) > 4 or
abs(sprite(flatlinesp).quad[3].loch - sprite(bottomcurvept).loch) > 4 then
      markcross
      exit
    end if
  end if
  if sprite(flatlinesp).member.linedirection = 1 then
    if abs(sprite(flatlinesp).quad[4].locv -
sprite(bottomcurvept).locv) > 4 or
abs(sprite(flatlinesp).quad[4].loch - sprite(bottomcurvept).loch) > 4 then
      markcross
      exit
    end if
  end if
  --top of curve meets stem of flat
  if abs(sprite(flatlinesp).right - sprite(topcurvept).loch) > 4 then
    markcross
    exit
  end if
```

The software then checks the spacing from the note to the closest horizontal line. If the space between the horizontal lines and the note are correct, a tick and associated comment appear on the screen. Conversely, if the space between the horizontal lines and the note is incorrect, the comment “Accidental is too close to note” or “Accidental is too far from note” appears on the screen. All the above checks must be deemed correct within the predetermined thresholds of the software for the drawing of the flat sign 820 to be correct. Marks are added to the score for each element the software checks.

The present invention also enables users to draw natural signs. The user draws four individual lines with the input device 120 onto the music staff 330 provided on the screen. The user selects the ‘draw line’ icon from the drop down menu on the screen and draws four lines with the input device 120, two horizontal lines and two vertical lines. These lines can be drawn in any order and when complete, the user selects the ‘marking’ button 350 to see if the natural sign has been drawn correctly. The software checks the angle, horizontal and vertical position of the natural sign in relation to the staff and the note on the staff, using predetermined parameters. The horizontal position of the natural sign is determined by its left-right relation to the staff. If its position is incorrect, an on-screen message appears, alerting the user to the error. This can be effected by the following suitable program code components:

```
on spacingfromnote
  -- check space between note & both vertical lines, check if either line is
too close the note
  if sprite(6).loch - (sprite(verticals[1]).loch or sprite(verticals[2]).loch)
< 26 then member(“comment”).text = member(“comment”).text &
“ Accidental is too close to note”
  if (sprite(verticals[1]).loch or sprite(verticals[2]).loch) - sprite(6).loch
> 65 then member(“comment”).text = member(“comment”).text &
“ Accidental is too far from note”
end
```

The software differentiates lines by recognising their horizontal and vertical location on the staff 330. The software checks that the correct four lines have been drawn. If the correct number of lines have been drawn, a tick and the comment “correct number of lines” appears on the screen. Conversely, if the number of lines drawn is incorrect, the comment “Note wrong number of lines” appears on the screen. This can be effected by the following suitable program code components:

```
on checknumberoflines
  listall = [ ]
  repeat with n = 1 to 10
    if sprite(100+n).puppet <> 0 then append(listall, n)
  end repeat
  if listall.count <> 4 then totallywrong
  if listall.count <> 4 then member(“comment”).text = “Used wrong
number of lines. ”
  if listall.count <> 4 then pass
end
```

The software differentiates lines by horizontal and vertical location on the staff 330. It first determines the vertical lines by virtue of the following exemplary program code components:

```
on findverticals
  verticals = [ ]
  note = 100
  repeat with t = 1 to 4
    if sprite(note + t).right − sprite(note + t).left <20 then append
(verticals, note+t)
  end repeat
  put verticals & “vertical list”
end
```

It then determines the horizontal lines by virtue of the following exemplary program code components:

```
on findhorizontals
  horizontals = [ ]
  note = 100
  repeat with u = 1 to 4
    if sprite(note + u).right − sprite(note + u).left >20 then append
(horizontals, note+u)
  end repeat
  put horizontals & “horizontals list”
end
```

The software checks the vertical placement of the natural sign. It determines whether the natural sign is too low or too high on the staff 330 relative to the placement of the note on the staff on the screen. If the natural sign is drawn in the correct vertical position on the staff, a tick and a comment appears on the screen. Conversely, if the natural sign is not drawn in the correct vertical position on the staff, the comment “natural is not vertically aligned with note” appears on the screen by virtue of the following exemplary program code components:

```
on checkrelativitynatural
  -- check box one answer
  -- check that the natural is not too high or too low
  if abs(((sprite(101).locv + sprite(102).locv + sprite(103).locv +
sprite(104).locv) /4) − (sprite(6).locv − 7))<15 then
    member(“comment”).text = member(“comment”).text & “”
    check1right
  else
    member(“comment”).text = member(“comment”).text & “ natural is
not vertically aligned with note, ”
    check1wrong
  end if
end
```

The software then determines the spacing between the vertical lines. If the space between the vertical lines are correct, a tick and the comment “vertical lines correctly spaced” appears on the screen. Conversely, if the space between the vertical lines is incorrect, the comment “Vertical lines of natural are too far apart.” or “Vertical lines of natural are too close together.” appears on the screen by virtue of the following exemplary program code components:

```
on spacingofverticals
  if abs (sprite(verticals[1]).loch − sprite(verticals[2]).loch ) > 30 then
member(“comment”).text = member(“comment”).text & “ Vertical lines
of natural are too far apart.”
  if abs (sprite(verticals[1]).loch − sprite(verticals[2]).loch ) < 8 then
member(“comment”).text = member(“comment”).text & “ Vertical lines
of natural are too far apart.”
end
```

The software then determines the spacing between the horizontal lines. If the space between the horizontal lines are correct, a tick and the comment “horizontal lines correctly spaced” appears on the screen. Conversely, if the space between the horizontal lines is incorrect, the comment “Horizontal lines of natural are too far apart.” or “Horizontal lines of natural are too close together.” appears on the screen by virtue of the following exemplary program code components:

```
on spacingofhorizontals
  if abs (sprite(horizontals[1]).locv − sprite(horizontals[2]).locv ) > 28
  then
member(“comment”).text = member(“comment”).text & “ Horizontal lines
of natural are too far apart.”
  if abs (sprite(horizontals[1]).locv − sprite(horizontals[2]).locv ) <10
  then
member(“comment”).text = member(“comment”).text & “ Horizontal lines
of natural are too close together.”
end
```

The software then checks the spacing from the note to the closest horizontal line. If the space between the horizontal lines and the note are correct, a tick and a suitable comment appears on the screen. Conversely, if the space between the horizontal lines and the note is incorrect, the comment “Accidental is too close to note” or “Accidental is too far from note” appears on the screen by virtue of the following exemplary program code components:

```
on spacingfromnote
  if sprite(6).loch − (sprite(verticals[1]).loch or sprite(verticals[2]).loch)
< 28 then member(“comment”).text = member(“comment”).text & “
Accidental is too close to note”
  if (sprite(verticals[1]).loch or sprite(verticals[2]).loch) − sprite(6).loch
> 65 then member(“comment”).text = member(“comment”).text & “
Accidental is too far from note”
end
```

The software then checks the angle of the horizontal lines. If the horizontal lines and the note are at an acceptable angle, i.e. within a predetermined threshold a tick and a suitable comment appears on the screen. Conversely, if the angle between the horizontal lines and the note is incorrect, the comment “One or more of the horizontals lines are drawn down and not drawn angled up.” appears on the screen by virtue of the following exemplary program code components:

```
on checkhorizontalangleup
  put sprite(horizontals[1]).quad[2].locv
  put sprite(horizontals[1]).quad[4].locv
  if (sprite(horizontals[1]).quad[2].locv >
sprite(horizontals[1]).quad[4].locv) or
(sprite(horizontals[2]).quad[2].locv >
sprite(horizontals[2]).quad[4].locv) then member(“comment”).text =
member(“comment”).text & “ One or more of the horizontals lines are
drawn down and not drawn angled up.”
end
```

The software then determines the length of the vertical lines. If the length of the vertical lines is correct, a tick and a suitable comment appears on the screen. Conversely, if the length of the vertical lines is incorrect, the comment “One or both of the vertical lines is too long.” or “One or both of the vertical lines is too short.” appears on the screen by virtue of the following exemplary program code components:

```
on checklengthverticals
  if sprite(verticals[1]).height >70 or sprite(verticals[2]).height >70 then
member(“comment”).text = member(“comment”).text & “ One or both of
the vertical lines is too long.”
  if sprite(verticals[1]).height < 31 or sprite(verticals[2]).height< 31 then
member(“comment”).text = member(“comment”).text & “ One or both
of the vertical lines is too short.”
end
```

The software then determines the length of the horizontal lines. If the length of the horizontal lines is correct, a tick and a suitable comment appears on the screen. Conversely, if the length of the horizontal lines is incorrect, the comment “One or both of the horizontal lines is too long.” or “One or both of the horizontal lines is too short.” appears on the screen by virtue of the following exemplary program code components:

```
on checklengthhorizontals
  if sprite(horizontals[1]).width >64 or sprite(horizontals[2]).width >64
  then
member(“comment”).text = member(“comment”).text & “ One or both
of the horizontal lines is too long.”
  if sprite(horizontals[1]).width <20 or sprite(horizontals[2]).width <20
  then
member(“comment”).text = member(“comment”).text & “ One or both
of the horizontal lines is too short.”
end
```

The software then determines the correct angle of the first horizontal line. If the angle of the first horizontal line is correct, a tick and a suitable comment appears on the screen. Conversely, if the angle of the first horizontal line is incorrect, the comment “First line is drawn wrong.” appears on the screen by virtue of the following exemplary program code components:

```
on checkfirstline
  --start and finish of left line
  --must start note.bottom and finish note.top + note.height
  if sprite(verticals[1]).loch < sprite(verticals[2]).loch then a =
verticals[1]
  if sprite(verticals[1]).loch > sprite(verticals[2]).loch then a =
verticals[2]
  put a &&“a”
  if abs (sprite(a).bottom − sprite(6).bottom ) < 6 then nothing --and abs
(sprite(6).top −sprite(a).top − sprite(6).height ) < 20
  else member(“comment”).text = member(“comment”).text & “ Seccond
line is drawn wrong.”
end
```

The software then determines the correct angle of the second horizontal line. If the angle of the second horizontal line is correct, a tick and a suitable comment appears on the screen. Conversely, if the length of the horizontal lines is incorrect, the comment “Second line is drawn wrong.” appears on the screen by virtue of the following exemplary program code components:

```
on checksecondline
  if sprite(verticals[1]).loch < sprite(verticals[2]).loch then a =
verticals[2]
  if sprite(verticals[1]).loch > sprite(verticals[2]).loch then a =
verticals[1]
  put a &&“a”
  if abs (sprite(a).top − sprite(6).top ) < 6 then nothing
  else member(“comment”).text = member(“comment”).text & “ second
line is drawn wrong.”
end
```

The software then determines the ratio between the length of the vertical lines compared to the length of the horizontal lines. If the ratio between the length of the vertical and horizontal lines are correct, i.e. within a predetermined threshold, a tick and the comment “lines correctly spaced” appears on the screen. Conversely, if the ratio between the length of the vertical and horizontal lines is incorrect, the comment “width too wide compared to height.” appears on the screen by virtue of the following exemplary program code components:

```
on checkHeightLengthRatio
  if sprite(horizontals[1]).width < (0.6 * sprite(verticals[1]).height) and
sprite(horizontals[2]).width < (0.6 * sprite(verticals[2]).height) then
nothing
  else member(“comment”).text = member(“comment”).text & “width
too wide compared to height.”
End
```

The software then determines the intersection of the vertical and horizontal lines. If the intersection of the vertical and horizontal lines are correct, i.e. within a predetermined threshold, a tick and a suitable comment appears on the screen. Conversely, if the ratio between the length of the vertical and horizontal lines is incorrect, the comment “incorrect joins.” appears on the screen by virtue of the following exemplary program code components:

```
on checkallcorners
  --a is left line
  --b is top line
  if sprite(verticals[1]).loch < sprite(verticals[2]).loch then
    a = verticals[1]
    b = verticals[2]
  end if
  if sprite(verticals[1]).loch > sprite(verticals[2]).loch then
    a = verticals[2]
    b = verticals[1]
  end if
  if sprite(horizontals[1]).locv < sprite(horizontals[2]).locv then
    c = horizontals[1]
    d = horizontals[2]
  end if
  if sprite(horizontals[1]).locv > sprite(horizontals[2]).locv then
    c = horizontals[2]
    d = horizontals[1]
  end if
  --conditionA
  if abs( sprite(a).bottom − sprite(d).bottom) < 5 and abs( sprite(c).left −
sprite(a).left) < 5 and abs( sprite(d).left − sprite(a).left) < 5 and abs(
sprite(c).top − sprite(b).top) < 5 and abs( sprite(d).right − sprite(b).left)
< 5 and abs( sprite(c).right − sprite(b).left) < 5 then nothing
  else member(“comment”).text = member(“comment”).text &
  “ incorrect joins.”
end
```

According to some embodiments, all the above checks must be deemed correct within the thresholds of the software for the drawing of the natural to be marked correct. Marks are added to the score for each element the software checks.

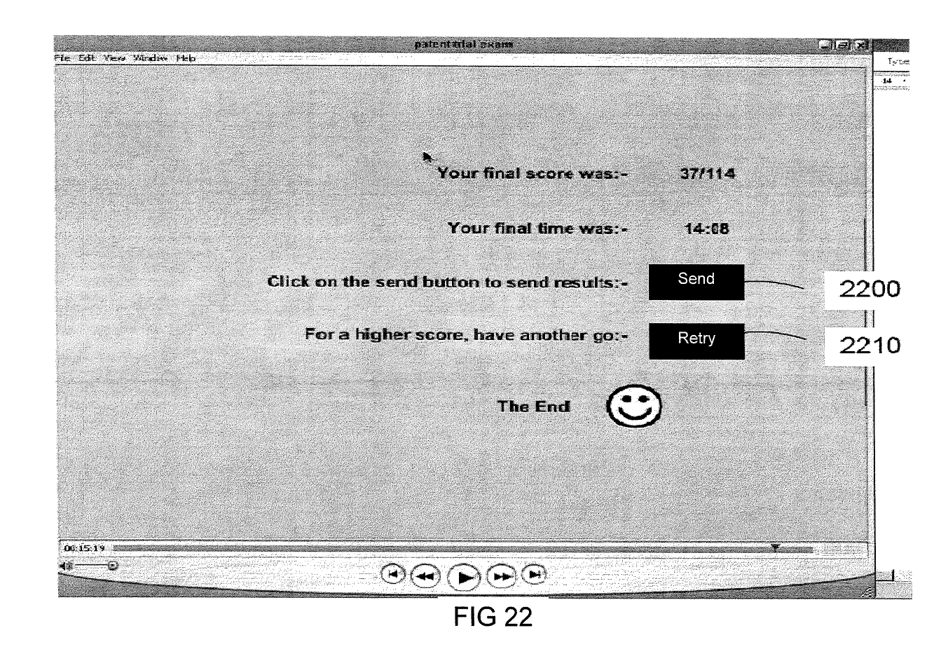

According to one embodiment, an online examination comprises multiple questions of the type described above. A user inputs an identifier, such as their name and a password, which is matched to their name and password stored in the storage facility 150. If the name and password combination is correct, the user proceeds to the examination, otherwise the name and password need to be re-entered. Buttons to direct the user to the individual exam questions are displayed in the main menu. The user clicks on the question they wish to answer and the software moves to that question. The user can return to the main menu at any time. The user answers questions in any order and can return to any question at any time during the examination. At the end of the examination the user presses a send button 2200 as shown in FIG. 22. The software marks each question and sends the results and a copy of the user's answers to the database 150. A report of the exam with detailed comments and marks is also generated by suitable program code components. The appropriate authority, such as a music examination board, can respond to the user with the results and can check results for quality control. With reference to FIG. 22, a score and a time taken for the examination can be displayed on screen and the user can choose to send the examination or retry in an attempt to achieve a higher score via retry button 2210. Where the examination is a final examination, the retry option may not be available.

The user answers each question in the space provided on screen drawing and assembling the appropriate musical notation and elements thereof as used in questions that require multiple symbol answers. The user's answers are held in global variables until the send button 2200 is pressed. When the send button is pressed the user's answers are sent to the database 150 as text strings and the database 150 can convert the text strings into graphics and recreate the user's graphical answer. Suitable program code components for performing the aforementioned functions when the send button 2200 is pressed follow:

```
on mouseup me
  numquestions = member(“number of questions”).text
  q1 = member(“Q1aComment”).text
  q2 = member(“Q1bComment”).text
  q3 = member(“Q1cComment”).text
  q4 = member(“Q2aComment”).text
  q5 = member(“Q2bComment”).text
  q6 = member(“Q2cComment”).text
  q7 = member(“Q2dComment”).text
  q8 = member(“Q3aComment”).text
  q9 = member(“Q3bComment”).text
  q10 = member(“Q3cComment”).text
  q11 = member(“Q4aComment”).text
  q12 = member(“Q4bComment”).text
  q13 = member(“Q4cComment”).text
  q14 = member(“Q4dComment”).text
  q15 = member(“Q4eComment”).text
  q16 = member(“Q4fComment”).text
  q17 = member(“Q5Comment”).text
  q18 = member(“Q6Comment”).text
  q19 = member(“Q7aComment”).text
  q20 = member(“Q7bComment”).text
  q21 = member(“Q7cComment”).text
  if q1 = “” then q1 = “Q1a,5,0,0,0,0,0,0,Not attempted”
  if q2 = “” then q2 = “Q1b,5,0,0,0,0,0,0,Not attempted”
  if q3 = “” then q3 = “Q1c,4,0,0,0,0,0,Not attempted”
  if q4 = “” then q4 = “Q2a,10,0,0,Not attempted”
  if q5 = “” then q5 = “Q2b,10,0,0,Not attempted”
  if q6 = “” then q6 = “Q2c,2,0,0,0,Not attempted”
  if q7 = “” then q7 = “Q2d,2,0,0,0,Not attempted”
  if q8 = “” then q8 = “Q3a,5,0,0,0,0,0,0,Not attempted”
  if q9 = “” then q9 = “Q3b,5,0,0,0,0,0,0,Not attempted”
  if q10 = “” then q10 = “Q3c,3,0,0,0,0,Not attempted”
  if q11 = “” then q11 = “Q4a,2,0,0,0,Not attempted”
  if q12 = “” then q12 = “Q4b,2,0,0,0,Not attempted”
  if q13 = “” then q13 = “Q4c,1,0,0,Not attempted”
  if q14 = “” then q14 = “Q4d,1,0,0,Not attempted”
  if q15 = “” then q15 = “Q4e,1,0,0,Not attempted”
  if q16 = “” then q16 = “Q4f,3,0,0,0,Not attempted”
  if q17 = “” then q17 = “Q5,19,0,0,Not attempted”
  if q18 = “” then q18 = “Q5,14,0,0,Not attempted”
  if q19 = “” then q19 = “Q7a,8,0,0,0,0,0,0,0,0,0,Not attempted”
  if q20 = “” then q20 = “Q7b,5,0,0,0,0,0,0,Not attempted”
  if q21 = “” then q21 = “Q7c,5,0,0,0,0,0,0,Not attempted”
    userNamevar = externalParamValue(“sw1”)
  passWord = externalParamValue(“sw2”)
  firstName = externalParamValue(“sw3”)
  lastName = externalParamValue(“sw4”)
  testId = externalParamValue(“sw5”)
  -- Use variables to create a URL to pass data back to the database.
  urltext = “/members/popup2.php?type=test&id=”& testId
&“&username=”& userNamevar &“&password=”& passWord
&“&numquestions=”& numquestions & “&q1=”&
q1 &“&q2=”& q2 &“&q3=”& q3 &“&q4=”& q4 &“&q5=”&
q5 &“&q6=”& q6 &“&q7=”& q7 &“&q8=”& q8 &“&q9=”&
q9 &“&q10=”& q10 &“&q11=”& q11 &“&q12=”& q12 &“&q13=”& q13
&“&q14=”& q14 &“&q15=”& q15 &“&q16=”& q16 &“&q17=”& q17
&“&q18=”& q18 &“&q19=”& q19 &“&q20=”& q20 &“&q21=”& q21
  gotonetpage (urltext)
end
```

The results of marking each question are sent to the database 150 and a report is generated with each question marked. In some embodiments, the marks and comments are compiled into a table, which can be emailed to the user and the appropriate authority in the form of the examination result.

According to some embodiments, when the send button 2200 is pressed, the position of every bitmap and text is stripped from the user's answer and converted to a string to copy the answers, but in a list format. The name of the graphic and its location is thus copied and transmitted to the database 150. This avoids the need to send a large graphic file that would take a long time to upload. An exact copy of all the graphics used for the examination is stored in the database 150. The server can then recreate the graphics of users' answers for quality control purposes and/or to address any disputes. Suitable program code components for performing this function when the send button is pressed follow:

```
on makelistforServer
  member(“qu17list”).text = “”
  qu1list = [:]
  myitem = 0
  repeat with sp = 1 to 320
    if sprite(sp).member <> member (0) then
      myitem = myitem + 1
      if sprite(sp).member.type = #text then sptextin =
sprite(sp).member.text
      else sptextin = “”
      if sprite(sp).member.type = #shape then splineWidthin =
sprite(sp).linesize
      else splineWidthin = “”
      if sprite(sp).member.type = #vectorshape then splineEquationIn =
sprite(sp).member.vertexlist
      else splineEquationIn = “”
      addprop qu1list, #newitem, [#itemNum: myitem, # spNum: sp, #
spMember: sprite(sp).member, #sploc: sprite(sp).loc, #spink:
sprite(sp).ink, #sptext:sptextin, #sprect:sprite(sp).rect,
#splineWidth: splineWidthin, #splineEquation: splineEquationIn]
          end if
  end repeat
    member(“qu17list”).text = string(qu1list)
end
```

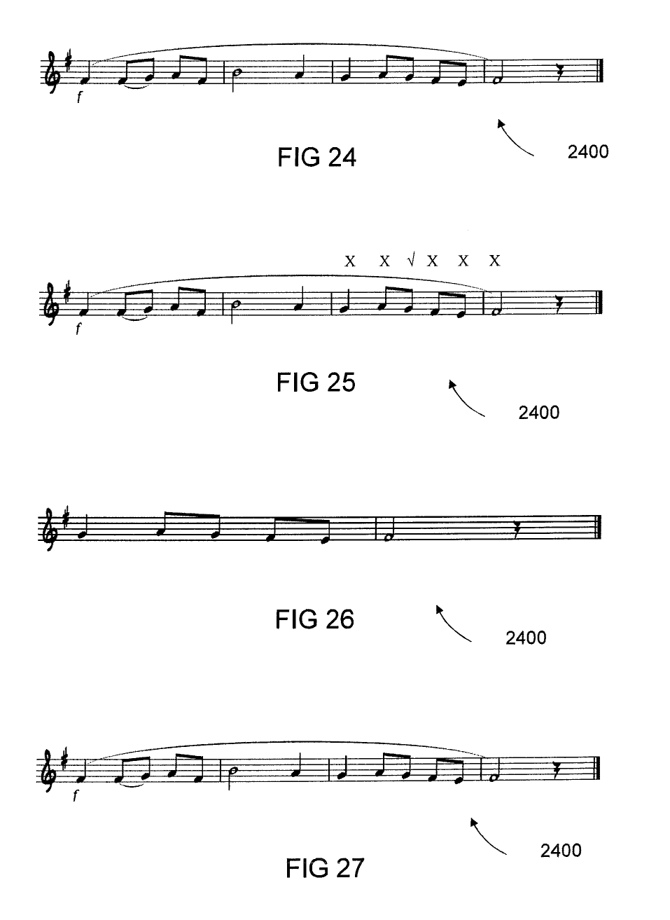

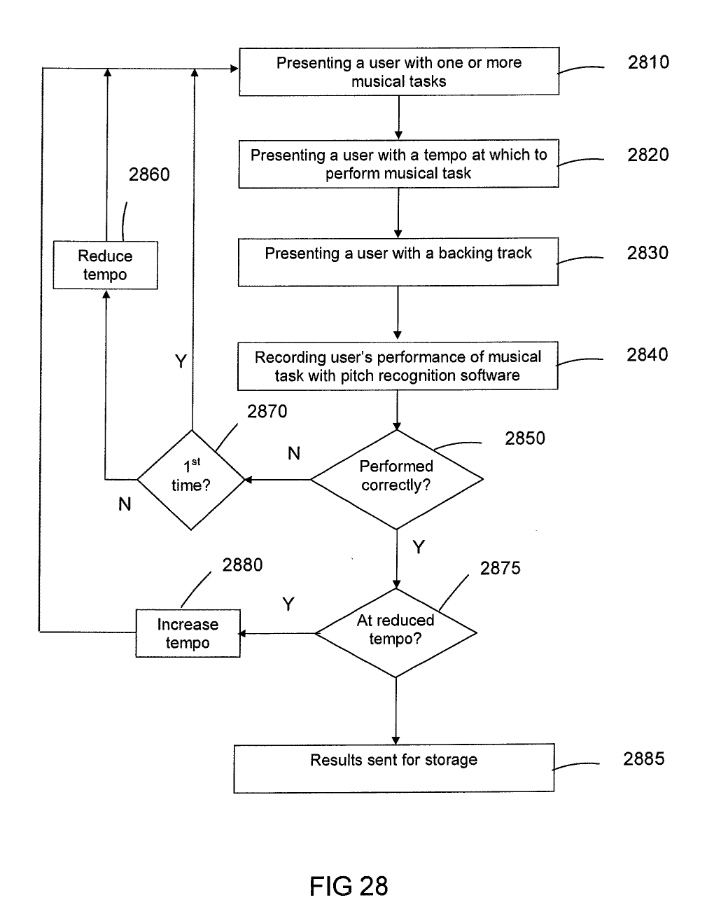

Further embodiments of the present invention will now be described with reference to the musical tasks shown in FIGS. 24-27 and the general flow diagram illustrating methods 2800 shown in FIG. 28. According to some embodiments, methods 2800 of examining in the field of music include at step 2810 presenting a user with one or more musical tasks to perform. For example, as shown in FIG. 24, such methods can include presenting the user with musical notation 2400, which represents a piece of music the user is required to play.

According to some embodiments, the method 2800 includes at step 2820 presenting a tempo to the user at which the music represented by the musical notation 2400 must be performed. For example, an audible periodic sound, such as metronome clicks, can be generated by the processor 130 at the required tempo.

According to some embodiments, the method 2800 includes at 2830 playing a backing track along to which the user can play. Optionally the user can listen to the backing track via headphones whilst playing the music represented by musical notation 2400.

It will be appreciated that steps 2810-2830 can occur simultaneously.

The method 2800 includes at 2840 recording the music performed by the user via microphone 170 in response to the one or more musical tasks. Any known pitch recognition software technology can be used for recording the music such that the pitch of the music played by the user is accurately recognized by the apparatus 105.

Once the piece of music performed by the user has been recorded, the method 2800 includes at 2850 comparing the recorded music with one or more predetermined thresholds. As with other embodiments described herein, the threshold can be set according to the level or standard being assessed. For example, tolerances within 1%, 2%, 3%, 4%, 5%, 10% etc. of the correct pitch can be set for the predetermined thresholds such that a note played within the predetermined threshold is considered by the apparatus 105 to be correctly played. The method can include generating a mark based on the result of the comparison. For example, with reference to the example shown in FIG. 25, only one of the six notes on the right hand side has been marked as being played at the correct pitch by the user.

With reference to FIG. 26, where the user commits one or more errors in performing the one or more musical tasks, the method 2800 includes representing the user with at least part of the one or more musical tasks previously presented, such as the musical notation 2400, but at a reduced tempo. Reducing the tempo is shown at step 2860 of method 2800. The re-presented part of the musical task can be the full task or just the part that the user has previously played incorrectly. FIG. 26 shows just the part of the musical task 2400 that the user previously played incorrectly at 60% of the original tempo. It will be appreciated that other percentages or fractions of the original tempo can be employed.

According to some embodiments, where the user commits one or more errors in performing the one or more musical tasks, the musical task 2400 can first be re-presented in its original form at the original tempo before the musical task 2400 or part thereof is re-presented at a reduced tempo. If errors are still made with the original tempo, the musical task 2400 or part thereof can then be re-presented at a reduced tempo. For example, if the musical task is incorrectly performed, i.e. is performed outside the predetermined thresholds, with reference to step 2870, if it is the first time the musical task has been performed incorrectly, the musical task 2400 can first be re-presented in its original form at the original tempo. If the user then incorrectly performs the musical task a second time at the original tempo, the musical task or part thereof can be represented at a reduced tempo. It will be appreciated that the number of times the user is presented with the original task at the original tempo can vary between embodiments and may depend on the level or standard being examined.

According to some embodiments and with reference to steps 2850 and 2875, where the user performs the one or more musical tasks correctly at the reduced tempo, the method includes re-presenting the user with at least part of the one or more musical tasks 2400 previously presented, but at a tempo increased from the reduced tempo. Increasing the tempo is shown at step 2880 of method 2800. The musical tasks 2400 or part thereof can be re-presented at consecutively higher tempos and with each correct performance by the user the tempo can be increased until the original tempo of the musical task 2400 is achieved.

According to some embodiments, where just the erroneously performed part of the musical task 2400 is re-presented and performed at consecutively higher tempos, once the erroneously performed part is played correctly by the user at the original tempo, the original musical task 2400 is re-presented to the user at the original tempo and the user's performance recorded and marked.

It will be appreciated that where just the erroneously performed part of the musical task 2400 is re-presented to the user, the backing track may be omitted.

Each performance by the user is recorded and with reference to step 2885 of the method 2800, when the send button 2200 is pressed, the results are transmitted to the storage facility 150 including the errors marked and the percentage of the original tempo achieved.

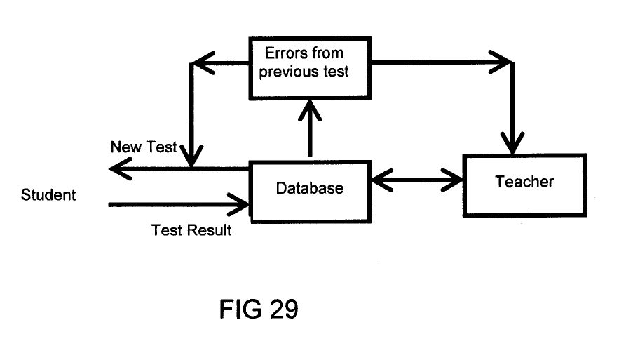

More embodiments of the present invention will now be described with reference to the schematic flow diagram shown in FIG. 29. The aforementioned system, methods and apparatus can be used for teaching and examining other subjects in addition to music, such as, but not limited to, mathematics, languages, humanities, such as geography, science, technology, business studies etc.

For example, a method of teaching and examining a subject according to some embodiments of the present invention includes generating a lesson for the subject from a store of components related to the subject. The store can be in the form of the storage facility 150, such as a database.

According to some embodiments, the method includes generating a lesson for the duration of a learning period, such as for each week of an educational term or year.

The method includes presenting a user with the lesson comprising one or more tasks related to the subject. Each task can comprise one or more of the components. The components related to the subject can be, for example, lists of words, clauses and/or sentences to be taught to a user as part of a language course; images relating to a humanities course, such as a silhouette or outline of a country for the task of identification of the country by a user; equations to be solved by the user as part of a mathematics course; chemical symbols, process diagrams, flow diagrams or apparatus diagrams as part of science course, for example, where a user is required to identify the element or compound, process parameters, stages or apparatus components respectively.

Other tasks can be selected from the following: selecting the odd one out from a group or class of items; inputting a word, clause and/or sentence in response to the word, clause and/or sentence being audibly presented; identifying a misspelt word and inputting the word correctly; pronouncing a word, clause and/or sentence which is recorded in response to the word, clause and/or sentence being displayed on screen. Suitable known voice recognition technology can be employed to assess whether the word, clause and/or sentence has be correctly pronounced or pronounced within prescribed thresholds.

It will be appreciated that the components related to the subject and the tasks to be completed are not an exhaustive list and are merely illustrative of how the present invention can be used to teach and examine other subjects.

The method further includes providing a menu with one or more selectable icons, selection of one of said icons activating functionality to enable the user to submit one or more responses to the one or more tasks.

The method also includes generating a mark based on the result of comparing the one or more responses with one or more predetermined thresholds. For example, in some subjects, there may not be a single correct answer and the predetermined thresholds can be set according to the subject being taught/examined and/or the level or standard being taught/examined.

With reference to FIG. 29, when the send button is pressed, the results are transmitted to the storage facility 150, such as the database, including the errors in the responses provided by the user.

Embodiments of the method include presenting the user with a modified lesson comprising one or more tasks related to the subject previously answered incorrectly by the user. Hence, embodiments of the invention customize the lessons for each user according to one or more previous performances by the respective user. A teacher, tutor or mentor can access the database to view the compiled results and monitor the users' progress.

Whilst the system, methods and apparatus described above in relation to FIG. 29 can be used for teaching and examining subjects other than music, it will be appreciated that such systems, methods and apparatus can also be used for teaching music.

It will be appreciated that the processor 130 activates functionality stored in the memory 140 in the form of computer readable program code components 145, at least some of which are selected to execute the methods of examining in the field of music and the methods of teaching and examining other subjects as described herein.

It will also be appreciated that features of the system, methods and apparatus described herein for teaching and examining in the field of music, which include recording the music performed by the user, and the system, methods and apparatus for teaching and examining other subjects, can be combined with earlier embodiments described herein. For example, embodiments which include requiring the user to form an element of musical notation can also include requesting the user to perform one or more notes, which are recorded and assessed. In another example, embodiments include re-presenting the user with one or more tasks requiring the user to form an element of musical notation which can include tasks previously presented to the user, but which were answered incorrectly by the user.

It should be appreciated that an important aspect of the present invention is that the predetermined thresholds used to determine whether the users' answers are correct are adjustable according to, for example, the level or standard being examined and/or the requirements of a particular examination authority. For example, greater tolerance or deviation from an exactly correct value can be set via the predetermined thresholds for lower level examinations. For example, for lower level examinations, the predetermined threshold can be set such that an angle in a user's answer must be within 30 degrees of the correct angle. For higher level examinations, the predetermined threshold can be set such that an angle in a user's answer must be within 10 degrees of the correct angle. Similar variations in the predetermined thresholds can be employed for other subjects being taught and examined.

The aforementioned exemplary program code components have been provided for enablement purposes and it will be appreciated that the functionality of the present invention can be achieved using alternative program code components written in alternative languages. In one embodiment, the program code components are executed in Macromedia Director, but alternative applications can be employed. It will further be appreciated that the lessons and examinations can comprise a wide range of questions, only a sample of which have been described herein.

Hence, the electronic system, methods and apparatus for teaching and examining music and other subjects of the present invention thus provide solutions to the aforementioned problems of the prior art. The embodiments of the present invention provide a series of lessons and examinations to educate the user in all aspects of music theory and other subjects and assess their competency in the skills they have acquired. Regarding music theory, the user can be taught how, and assessed on, the correct formation and positioning of musical notation using one or more menus comprising icons the selection of which enables the user to form an element of musical notation, such as a stem, head, curve etc. Alternatively, where other skills are being taught and assessed, the user is provided with one or more menus with the notes and other musical symbols already formed for insertion on a preformed staff.

According to some embodiments, the user can have as many attempts as they desire at the exercises to reinforce the principals without the need to erase their previous answer as would be required with some of the prior art. Instant feedback is provided to the user in the form of hints, tips and marks on their answers in sharp contrast to the prior art where there is often a significant delay in providing feedback. The animation capabilities of the present invention enhance the learning experience and the user is also able to hear the notes and tunes forming at least part of the answer. Users can also be recorded, for example, in terms of their performance of a piece of music or pronunciation of a word, clause or sentence in their native language or a foreign language.

Marking of the questions is immediate and automatic upon the user requesting their answer(s) to be marked, thus avoiding the costs incurred with the prior art of having each answer paper marked individually and manually. The system of the present invention enables users in one or more locations to be taught and examined and users, tutors and examining authorities can be provided with instant feedback on the users' progress and the grades achieved. Furthermore, automatic tabulation of the results enables comparisons to be easily made between the results. Such comparisons may be, for example, between different results of the same user of between results for the same examination or level of different users.

Throughout the specification the aim has been to describe the invention without limiting the invention to any one embodiment or specific collection of features. Persons skilled in the relevant art may realize variations from the specific embodiments that will nonetheless fall within the scope of the invention.

What is claimed is:

1. A method of examining in the field of music, said method including:
presenting a user with one or more musical tasks;
recording music performed by the user in response to the one or more musical tasks; and
generating a mark based on the result of comparing the recorded music with one or more predetermined thresholds.

2. The method of claim 1, including presenting one or more of the following to the user: musical notation to perform; a tempo at which the music must be performed; an audible periodic sound representing a tempo at which the music must be performed; a backing track along to which the user is requested to play.

3. The method of claim 1, including re-presenting the user with at least part of the one or more musical tasks previously presented, but at a reduced tempo, where the user commits one or more errors in performing the one or more musical tasks.

4. The method of claim 3, including re-presenting the user with at least part of the one or more musical tasks previously presented, but at a tempo increased from the reduced tempo, where the user performs the one or more musical tasks correctly at the reduced tempo.

5. A method of teaching and examining a subject, said method including:
generating a lesson for the subject from a store of components related to the subject;
presenting a user with the lesson comprising one or more tasks related to the subject;
providing a menu with one or more selectable icons, selection of one of said icons activating functionality to enable the user to submit one or more responses to the one or more tasks; and
generating a mark based on the result of comparing the one or more responses with one or more predetermined thresholds.

6. The method of claim 5, including presenting the user with a modified lesson comprising one or more tasks related to the subject previously answered incorrectly by the user.

7. The method of claim 6, including generating a series of lessons for the duration of a learning period, such as for each week of an educational term or year.

8. The method of claim 5, wherein the tasks can be selected from the following:
inputting a word, clause and/or sentence in response to the word, clause and/or sentence being audibly presented; inputting the result of an equation; inputting the name of a country in response to the display of a silhouette of a country; identifying a misspelt word; identifying the odd one out in a series; pronouncing a word, clause and/or sentence, which is recorded, in response to the word, clause and/or sentence being presented.

9. An apparatus for examining in the field of music, said apparatus comprising:
computer readable program code components configured to present a user with one or more musical tasks;
computer readable program code components configured to record music performed by the user in response to the one or more musical tasks; and
computer readable program code components configured to generate a mark based on the result of comparing the recorded music with one or more predetermined thresholds.

10. The apparatus of claim 9 comprising computer readable program code components configured to perform one or more of the following:
(a) present one or more of the following to the user: musical notation to perform; a tempo at which the music must be performed; an audible periodic sound representing a tempo at which the music must be performed; a backing track along to which the user is requested to play;
(b) re-present the user with at least part of the one or more musical tasks previously presented, but at a reduced tempo, where the user commits one or more errors in performing the one or more musical tasks; and
(c) re-present the user with at least part of the one or more musical tasks previously presented, but at a tempo increased from the reduced tempo, where the user performs the one or more musical tasks correctly at the reduced tempo.

11. An apparatus for teaching and examining a subject, said apparatus comprising computer readable program code components configured to:
generate a lesson for the subject from a store of components related to the subject;
present a user with the lesson comprising one or more tasks related to the subject;
provide a menu with one or more selectable icons, selection of one of said icons activating functionality to enable the user to submit one or more responses to the one or more tasks; and
generate a mark based on the result of comparing the one or more responses with one or more predetermined thresholds.

12. The apparatus of claim 11 further comprising computer readable program code components configured to:
present the user with a modified lesson comprising one or more tasks related to the subject previously answered incorrectly by the user.

13. The apparatus of claim 12 further comprising computer readable program code components configured to:
generate a series of lessons for the duration of a learning period, such as for each week of an educational term or year.

14. The apparatus of claim 11 further comprising computer readable program code components configured to present the user with tasks selected from the following:
inputting a word, clause and/or sentence in response to the word, clause and/or sentence being audibly presented; inputting the result of an equation; inputting the name of a country in response to the display of a silhouette of a country; identifying a misspelt word; identifying the odd one out in a series; pronouncing a word, clause and/or sentence, which is recorded, in response to the word, clause and/or sentence being presented.
